(19) United States
(12) Patent Application Publication
(10) Pub. No.: US 2024/0122130 A1
(43) Pub. Date: Apr. 18, 2024

(54) MUSHROOM GROWING SYSTEM AND METHOD

(71) Applicant: Silo Farms, LLC, Springfield, MO (US)

(72) Inventor: Bradford Kuhns, Ontario (CA)

(21) Appl. No.: 18/547,007

(22) PCT Filed: Feb. 25, 2022
(86) PCT No.: PCT/US2022/017926

§ 371 Date: Aug. 18, 2023

Related U.S. Application Data
(60) Provisional application No. 63/154,087, filed on Feb. 26, 2021.

(51) Int. Cl. A01G 18/62

(52) U.S. Cl. CPC A01G 18/62

(57) ABSTRACT

A container assembly for a mushroom growing system includes a tray and a plurality of containers. The tray includes a plurality of tray locating structures attached relative to one another and spaced horizontally to cooperatively define a supporting tray surface of the tray. Each container is biodegradable and is configured to be removably supported by the tray. The container includes a cup and a container cover that present an enclosed chamber to receive a colonized substrate for growing mushrooms.

### CROSS-REFERENCE TO RELATED APPLICATIONS

The present application claims the priority benefit of U.S. Provisional Patent Application Ser. No. 63/154,087, filed Feb. 26, 2021, entitled MUSHROOM GROWING SYSTEM AND METHOD, which is hereby incorporated by reference in its entirety herein.

### BACKGROUND

### Field

The present invention relates generally to mushroom growing systems with one or more containers supported by a tray for specialty mushroom production. Embodiments of the present invention include biodegradable containers that contain a mycelium-populated substrate for growing a mushroom crop and are configured to facilitate crop movement and transportation.

### Description of Related Art

The specialty mushroom industry is a segment of the worldwide mushroom industry describing all mushrooms other than the Agaricus genus of mushrooms. Agaricus production makes up 70-90% of the worldwide market and is most known by the common white button mushroom, Portobello and other similar varieties most popular in grocery stores. The majority of the other mushrooms such as Oyster, Shiitake, Lions mane and others are wood eating mushrooms that do not require manure however they typically require more sterile production methods to eliminate all competitive biology. Their yields are typically enhanced by adding Nitrogen rich protein supplements and or minerals that can include soybean hulls, wheat middlings, bran, cottonseed hulls, brewery waste, soybean meal, alfalfa and many other nitrogen rich agricultural byproducts. Specialty mushrooms are primary and secondary composters unlike Agaricus varieties which are tertiary composters typically requiring inputs like manure and or other composted materials which is inherently biologically rich and active. Specialty mushrooms by contrast compete with other biological microorganisms for the nitrogen rich inputs and therefore most specialty mushroom cultivation involves sterilizing or ultra-pasteurizing substrate to eliminate competitor microorganisms. The aseptic workflow involves HEPA flow hoods and near sterile procedures for handling cultures, spawn and sterilized or pasteurized media inoculation with mushroom culture and treating the woody and supplements with heat or radiation before inoculation with sterile culture. Once fully colonized with mycelium, the bags or bottles of substrate are introduced to changing environmental conditions of temperature and humidity and then given fresh air to surface locations that expose mycelium to the environment directly. This provokes the fruiting response of mycelium to produce mushrooms which are the familiar fruit bodies of fungus. Each bag or bottle must be individually or mechanically initiated to poke holes in the bags or remove lids from the bottles.

There are three (3) major classifications of production techniques in commercial production of specialty mushrooms: Gamma irradiation, heat sterilization by autoclaving and long duration atmospheric ultra-pasteurization. The latter two typically mix sawdust and supplement with water and are filled into plastic bags, bottles or bulk containers which can withstand high temperature heat or steam treatment.

Conventional bags and bottles are configured to exclude foreign microorganisms and withstand heat treatment. However, these known containers require the use of plastic or other materials which are predominantly not recycled or biodegradable.

There are several disadvantages to the current standards of practice. Plastic for bag production is one-time use and requires specialized and costly filters to allow gas exchange through a membrane releasing excess CO2 and allowing fresh clean air into the microclimate of the incubating mushroom mycelium. These specialized bags are used to contain the mixture of sawdust, supplement and water through a heat processing. Plastic reusable bottles require cleaning and sanitizing prior to reuse, which is known to be mechanically complex and labor intensive. There are available biodegradable bags which are made of plastic that will break down in a reasonable time scale. However, all involve the use of plastic or often mixed use of dis-similar types of plastic making recycling difficult.

### SUMMARY

The following brief summary is provided to indicate the nature of the subject matter disclosed herein. While certain aspects of the present invention are described below, the summary is not intended to limit the scope of the present invention.

Embodiments of the present invention provide a mushroom growing system that does not suffer from the problems and limitations of prior art growing systems, including those set forth above.

A first aspect of the present invention concerns a dual-use tray configured to be interchangeable with one or more other dual-use trays and configured to support mycelium-populated containers alongside one another, with the containers having upper and lower container elements. The dual-use tray broadly includes a plurality of upper tray locating structures and a plurality of lower tray locating structures. The upper and lower tray locating structures are attached relative to one another and spaced horizontally to at least partly define respective upper and lower tray surfaces. Each of the upper tray locating structures presents an upper shoulder that forms part of the upper tray surface and is configured to locate the lower container element of a respective container. Each of the lower tray locating structures presents a lower shoulder that forms part of the lower tray surface and is configured to locate the upper container element of a corresponding container.

A second aspect of the present invention concerns a container assembly for a growing system. The container assembly broadly includes a supporting tray, a covering tray, and a plurality of containers. Containers have upper and lower container elements, with the trays configured to cooperatively hold the containers. The supporting tray includes a plurality of supporting tray locating structures attached relative to one another and spaced horizontally to cooperatively define an upper supporting tray surface of the supporting tray. Covering tray includes a plurality of covering tray locating structures attached relative to one another and spaced horizontally to cooperatively define a lower covering tray surface of the covering tray. The supporting tray locating structures are removably associated with respective covering tray locating structures to cooperatively engage the containers therebetween.

A third aspect of the present invention concerns a filtered container that broadly includes an elongated cup and a container cover. The cup includes a continuous tubular sidewall and a cup bottom. The sidewall extends vertically to present upper and lower ends, with the cup bottom fixed to the sidewall adjacent the lower end. The sidewall includes an endless rim extending along the upper end and defining an open top of the cup. The container cover is removably attached to the endless rim to cover the open top, with the cup and container cover cooperatively defining an enclosed chamber. The cup and container cover each include a biodegradable base layer and an internal lining. The internal lining is applied to the base layer to cover base layer surfaces within the chamber.

A fourth aspect of the present invention concerns a method of producing a mycelium-populated container for growing mushrooms. The method broadly includes the steps of providing a filtered container that includes a cup and a container cover, with the cup and container cover cooperatively defining an enclosed chamber; and adding a mixture of spawn and substrate material to the chamber, with the spawn and substrate material cooperatively providing a mycelium-populated substrate.

A fifth aspect of the present invention concerns a method of stacking alternating layers of containers and trays to form a container stack. Each tray includes a plurality of upper tray locating structures and a plurality of lower tray locating structures. The upper tray locating structures are coaxially aligned with the respective lower tray locating structures and the trays are interchangeable with one another. The method broadly includes the steps of having at least one of the trays selected as a lowermost tray in the container stack and positioned to receive containers; having a first array of containers positioned on the lowermost tray in engagement with upper tray locating structures thereof; and having at least one of the trays selected as a second tray above the lowermost tray in the container stack and positioned on the first array of containers so that the first array of containers engage lower tray locating structures of and cooperatively support the second tray.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Preferred embodiments of the invention are described in detail below with reference to the attached drawing figures, wherein:

FIG. 1 is a fragmentary perspective view of a silo growing system constructed in accordance with a preferred embodiment of the present invention, showing a silo building with a plurality of silos and a plurality of helix growing assemblies installed in the silos, with sections of silo walls removed to depict a schematic representation of the helix growing assemblies;

FIG. 2 is a fragmentary upper perspective view of one of the silos and helix growing assemblies shown in FIG. 1, showing a helix segment of the growing assembly supporting a train of movable carts, with the growing assembly including, among other things, a continuous helix track;

FIG. 3 is a fragmentary upper perspective view of the helix growing assembly, and one of the movable carts, with the cart supporting a series of pre-filled containers;

FIG. 4 is a fragmentary lower perspective view of the helix growing assembly, movable cart, and containers similar to FIG. 3, but showing an underneath view of the components;

FIG. 5 is an exploded perspective view of the movable cart and containers shown in FIGS. 3 and 4, with the cart including a frame, removable tray, and wheels;

FIG. 6 is an enlarged fragmentary cross-sectional view of the helix growing assembly, movable cart, and containers taken along line 6-6 in FIG. 3, showing pre-filled containers supported by the removable tray;

FIG. 7 is a lower perspective view of one of the pre-filled containers shown in FIGS. 3-6, with the container including an elongated cup and a container cover attached to a rim of the cup;

FIG. 8 is a fragmentary upper perspective of the pre-filled container shown in FIG. 7, showing a mycelium-populated substrate contained within an enclosed chamber of the container, with the mycelium-populated substrate including a mixture of a pelletized substrate material and spawn;

FIG. 9 is a fragmentary elevational view of the helix growing assembly, movable carts, and containers shown in FIG. 3, but showing the relative vertical positioning of adjacent carts and containers;

FIG. 10 is a fragmentary upper perspective view of a silo growing system constructed in accordance with a second embodiment of the present invention, showing a helix segment of the growing assembly supporting a movable cart and containers, with the cart including a frame, suspended supports, removable tray, and wheels;

FIG. 11 is a fragmentary lower perspective view of the helix growing assembly, movable cart, and containers similar to FIG. 10, but showing an underneath view of the components;

FIG. 12 is an exploded perspective view of the movable cart and containers shown in FIGS. and 11;

FIG. 13 is an upper perspective view of the removable tray shown in FIGS. 10-12, showing a plurality of upper tray locating structures surrounded by a rim and forming part of an upper tray surface, with the upper tray locating structures each including a ridge that defines an upper shoulder;

FIG. 13a is an enlarged fragmentary perspective view of the removable tray shown in FIG. 13, with the tray being cross sectioned to depict the profile of the upper tray locating structure;

FIG. 14 is a lower perspective view of the removable tray shown in FIGS. 10-13a, showing a plurality of lower tray locating structures surrounded by the rim and forming part of a lower tray surface, with the lower tray locating structures each including a ridge that defines a lower shoulder;

FIG. 14a is an enlarged fragmentary perspective view of the removable tray shown in FIG. 14, with the tray being cross sectioned to depict the profile of the lower tray locating structure;

FIG. 15 is a fragmentary cross-sectional view of the movable cart and containers taken along line 15-15 in FIG. 10, showing containers supported by respective upper tray locating structures, with the tray being supported by suspended supports of the movable cart;

FIG. 16 is an enlarged fragmentary elevational view of the movable cart and containers shown in FIGS. 10-12 and 15, showing containers supported by respective upper tray locating structures, with the containers and tray being cross sectioned to show ridges of the upper tray locating structures engaging the bottom of corresponding containers;

FIG. 17 is an upper perspective view of the removable tray and containers shown in FIGS. 10-12, 15 and 16, showing a plurality of upper tray locating structures surrounded by a rim and forming part of an upper tray surface, with the upper tray locating structures each including a ridge that defines an upper shoulder;

FIG. 18 is a fragmentary elevational view of the helix growing assembly, movable carts, and containers shown in FIGS. 10 and 11, but showing the relative vertical positioning of adjacent carts and containers;

FIG. 19 is a perspective view of a container assembly constructed in accordance with a third embodiment of the present invention, showing containers positioned on supporting trays, with covering trays located on the containers;

FIG. 20 is an upper perspective view of a movable cart constructed in accordance with a fourth embodiment of the present invention, showing a frame, removable trays, and wheels of the cart;

FIG. 21 is a lower perspective view of the movable cart shown in FIG. 20;

FIG. 22 is a lower perspective view of a pre-filled container constructed in accordance with a fifth embodiment of the present invention;

FIG. 23 is an upper fragmentary perspective view of the pre-filled container shown in FIG. 22, with the container being cross sectioned to depict mycelium-populated substrate within an enclosed chamber, and showing the lid partly removed to depict a rim with a generally planar upper sealing surface.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION

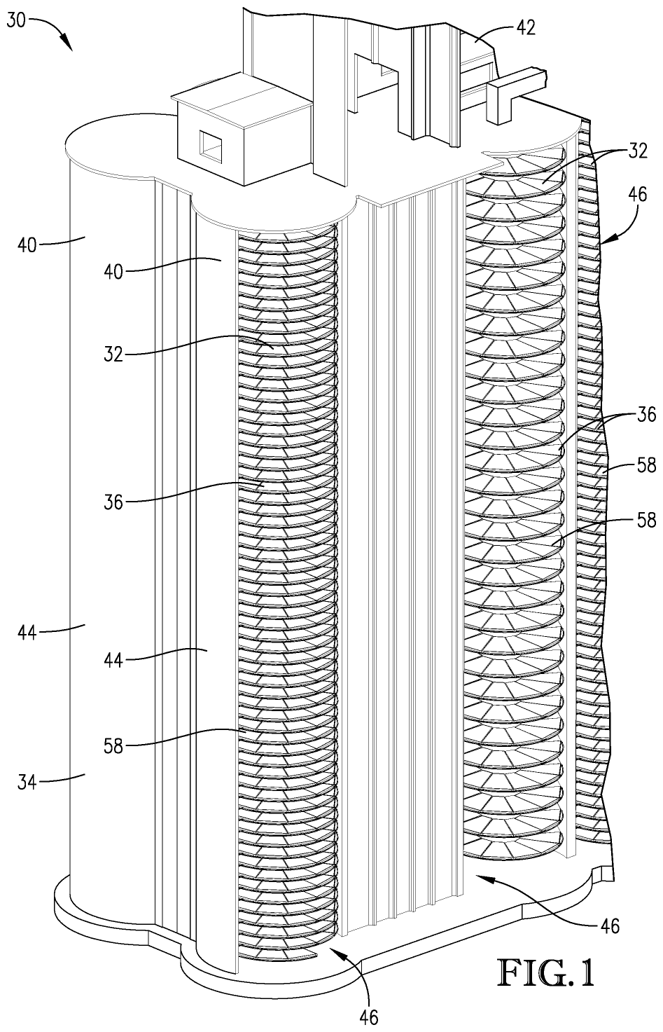

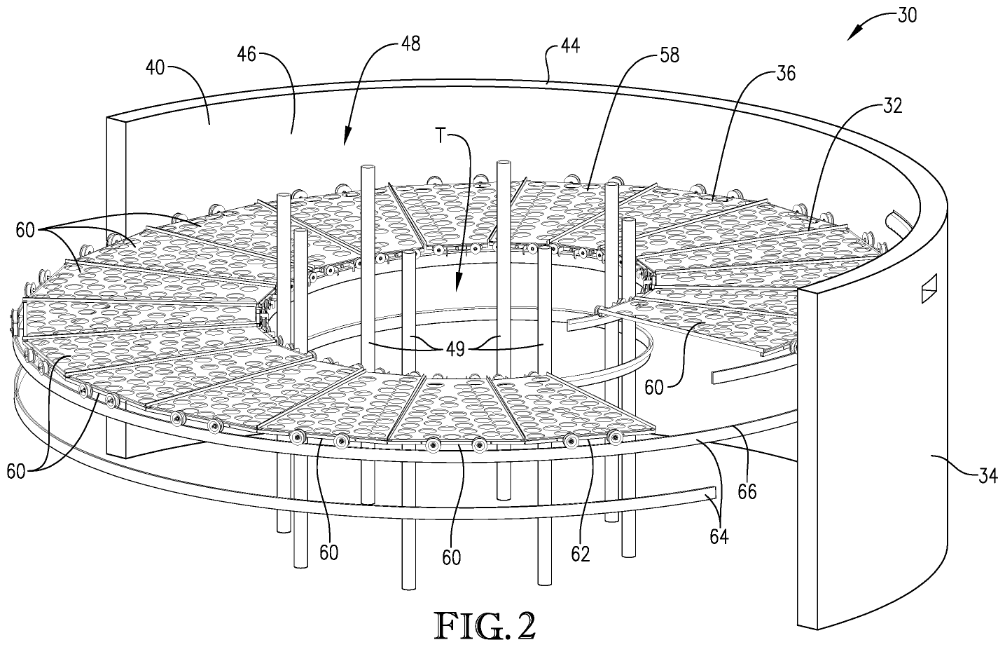

Turning initially to FIGS. 1 and 2, a silo growing system 30 provides a production facility for growing various crops C and is particularly configured for specialized mushroom production. The illustrated silo growing system 30 includes multiple helix growing assemblies 32 that each preferably have a vertical helix orientation. As used herein, features described as a “helix” or as being helically shaped may also be described as a spiral, a coil, or having the shape of a spiral or coil. The term “helix” may generally refer to a spiral shape with a diameter that is substantially constant along the length of the spiral or a diameter that varies along the length of the spiral. Thus, the term, as used herein, and unless otherwise specified from the context includes helical shapes with variable diameters (e.g., increasing or decreasing in diameter along the height of the helix) or invariable diameters (e.g., with a constant diameter along the height of the helix, subject to a reasonable tolerance for normal variations in construction). The term also covers substantially invariable helical shapes, which may then spiral out and have an increasing diameter at the bottom of the helix.

The helix growing assembly 32 is arranged on a vertically-oriented central access shaft T running along the axis of the helix. In this manner, a plurality of crop supports may be arranged in succession following the helical path of the vertically elongated helix track, winding downward around the central access shaft T. It will be appreciated that the depicted silo growing system is configured as a helix or coil with a preferably constant diameter, in contrast to a horizontal greenhouse conveyor system. However, for at least certain aspects of the present invention, various aspects of the disclosed system may be adapted for use in conventional mushroom growing systems.

As will be described in greater detail, the silo growing system 30 broadly includes helix growing assemblies 32, a silo building 34, and a plurality of movable crop supports 36.

In preferred embodiments, crops C of fungi (such as mushrooms provided in containers 38) may be grown using this system. Although the depicted containers 38 are preferred for growing fungi, it is within the scope of certain aspects of the present invention for alternative containers to be used to grow various types of mushrooms or other fungi. For instance, mushroom bags may be used for growing fungi (as depicted in the incorporated publication). While the illustrated embodiment depicts the use of system 30 to incubate mushrooms, it is entirely within the ambit of the present invention where the system 30 is configured to grow crops of other agricultural products.

As used herein, the term “fungi” generally includes, without limitation, mycelium, spawn, mushrooms, and similar terms. It will be understood that such fungi may be provided in the depicted bags, other types of fungi bags, or various other containers for fungi, or may be otherwise carried/supported by support structure suitable for fungi incubation. Furthermore, fungi may or may not be provided with various substrates, such as sawdust, straw, or other materials. It will be understood that a substrate can be colonized with fungi to provide various end products (e.g., fungi intended for mushroom fruit body production, a colonized substrate, pet-consumable or a human-consumable substrate). For instance, it is within the scope of the present invention where a plant substrate (e.g., millet, sorghum, edible grass or rice) is colonized with fungi. The colonized substrate can then be dried and ground into a nutrified medicinal product or a nutritionally enhanced flour. The colonized substrate could also serve as spawn for later use (e.g., by other growers). The containers 38 preferably include mushrooms but could also include various types of fungi.

In the depicted embodiment, containers 38 are populated or inoculated with mycelium (and/or other fungi), substrate, and nutrients to provide a pre-filled container. In various embodiments, it will be appreciated that the pre-filled container may be fully or partly “colonized,” such that the colonized substrate is ready for growing mushroom fruit. Similarly, the pre-filled container may only be fully or partly incubated, but not yet colonized. The pre-filled container may also be inoculated but not yet colonized or incubated. For ease of reference herein, the pre-filled container is referred as being “ready-to-fruit” meaning that the pre-filled container is at least inoculated and may be further partly or fully incubated, and/or partly or fully colonized (unless context otherwise dictates the pre-filled container is a provided at a defined stage of growth). In other words, the ready-to-fruit containers at the end of the inventive process are not yet fruited and/or ready for harvesting, but sealed and ready for further incubation, colonization, and/or fruiting (and eventually harvest). It is contemplated, however, that the process can be modified such that the fruiting stage is carried out in the helix to yield a fruited container, which can be harvested at the end of the helix and/or subsequent to removal from the helix.

In alternative embodiments, other crops of agricultural products may be grown using this system and may include plants and/or animals. Such agricultural crops can include, without limitation, lettuces, leafy greens, melons, berries, grapes, cannabis, herbs, insects, and the like. Thus, the crops may include vegetables, fruits, etc.

A “growth cycle” associated with a pre-filled container that is populated by mycelium may include container processing steps of inoculating, partly colonizing, fully colonizing, partly incubating, fully incubating, fruiting, or combinations thereof. In preferred embodiments, a growth cycle may range from about five (5) days to about one hundred (100) days. More preferably, growth cycles of crops may range from about twelve (12) days to about sixty (60) days, with the growth cycle typically being completed for harvesting when the crops reach the bottom of the helix; however, in the case of mycelium or other fungi, it is contemplated that the products are not necessarily grown to full fruiting, but rather only accomplish the inoculation, incubation, and/or colonization stages while in the helix and are then transferred as “ready-to-fruit” products to growers who complete the growth cycle and harvesting For certain aspects of the present invention, an alternative growth cycle may fall outside of the above-specified ranges. Thus, the speed of travel of the crop supports 36 may be adjusted accordingly. Further, the speed of travel may be constant (e.g., 2-inches per hour) or may involve periods of stop/start throughout the growth cycle.

The devices, systems, and methods disclosed herein relate to a crop growing system and methods that may provide application of water and/or nutrients to crops C of mushrooms (and/or other agricultural crops). Such application may include aeroponics, fogponics, etc. For certain aspects of the present invention, water and/or nutrients may be applied using other direct application methods, such as nutrient film technique (NFT).

As will be described, crops C are advanced downwardly through the silo 40 in/on crop supports 36 that travel through the growth chamber from the beginning of the growth cycle (top) to an end product location (bottom) that preferably corresponds to containers in the “ready-to-fruit” condition, as discussed above. Crops C may be exposed to a light source (e.g., artificial light) at appropriate intervals for the crop type as the crop support structure travels along the inventive crop conveyor system.

Additional details concerning preferred feeding and lighting configurations, growth cycles, and preferred feeding intervals are disclosed in U.S. Publication No. 2021/0007304, filed Sep. 25, 2020, entitled GROWING SYSTEM AND METHOD, which is hereby incorporated in its entirety by reference herein.

The illustrated silo building 34 houses the helix growing assemblies 32 and movable crop supports 36. The silo building 34 preferably comprises a conventional grain elevator that includes a plurality of vertical silos 40 arranged alongside one another. The silo building 34 also preferably includes a basement (not shown) that extends laterally beneath the silos 40 and a gallery 42 that extends laterally along the top of the silos 40.

The silos 40 are formed by respective silo walls 44 and define corresponding silo growth chambers 46 (see FIGS. 1 and 2). Each silo wall 44 also defines, in part, a respective helix growing space 48 that extends within the chamber 46 to receive crops C. As used herein, the term “silo growth chamber” refers to a chamber that is configured to receive various agricultural crops (such as plants, fungi, and/or animals) for growth and/or incubation. The silos 40 also preferably includes a plurality of vertical support columns 49 arranged about the central access shaft T (see FIG. 2). Each column 49 preferably comprises a structural beam fixed within the growing space 46.

The depicted silo growth chambers 44 are each vertically elongated. In particular, each chamber 44 has a generally cylindrical shape that extends vertically and has a circular profile. It will be understood that the silo growth chambers may be variously shaped without departing from the scope of the present invention. For example, one or more silo growth chambers could be shaped to have a profile that is generally square or rectangular.

In various embodiments within the scope of the present invention, the silo growing system is configured to include one or more vertically oriented housings or towers that can range in size. The terms “housing,” “tower,” or “silo” are used interchangeably herein to refer to the depicted silos and denote the vertically oriented, vertically elongated nature of the housing structure, which will typically have a height that is greater than its width. However, for certain aspects of the present invention, the silos (and silo growth chambers) could have an alternative ratio of height and width dimensions (e.g., where the height dimension is less than a width dimension). Additional preferred features of the silo building are disclosed in the above-incorporated '304 publication.

In alternative embodiments, one or more silos may be either freestanding or form part of a larger structure or grouping of a plurality of housing structures. In some embodiments, each silo is a cylindrically shaped, vertically elongated structure. Some embodiments of the system will utilize an existing grain silo/elevator or tower as an approach to reusing otherwise vacant structures that are available throughout much of the world. The silo may be made from a variety of materials, such as concrete, steel, and combinations thereof. The most efficient materials are selected to have both high strength and high thermal mass, such as concrete, steel, and the like. The thickness of the silo walls also contributes to the thermal stability of the system.

Alternative mushroom growing facilities suitable for use with containers 38 may comprise a conventional horizontal growing facility with one or more horizontal support structures, which may include stationary and/or movable support elements. For instance, suitable horizontal support structures may include without limitation, shelves, trays, tables, screens, and/or conveyor belts.

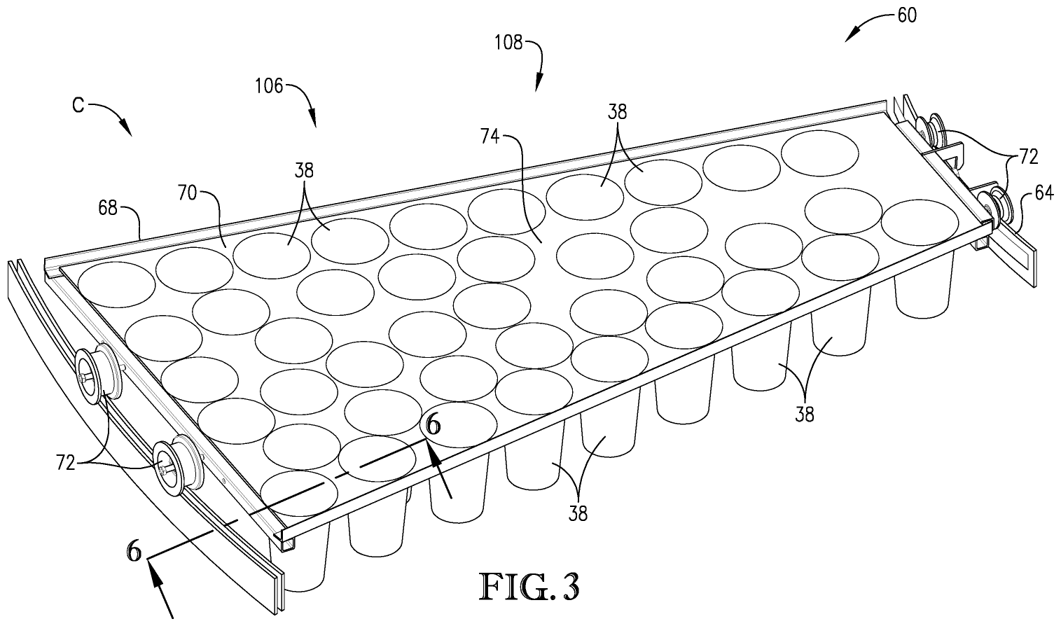

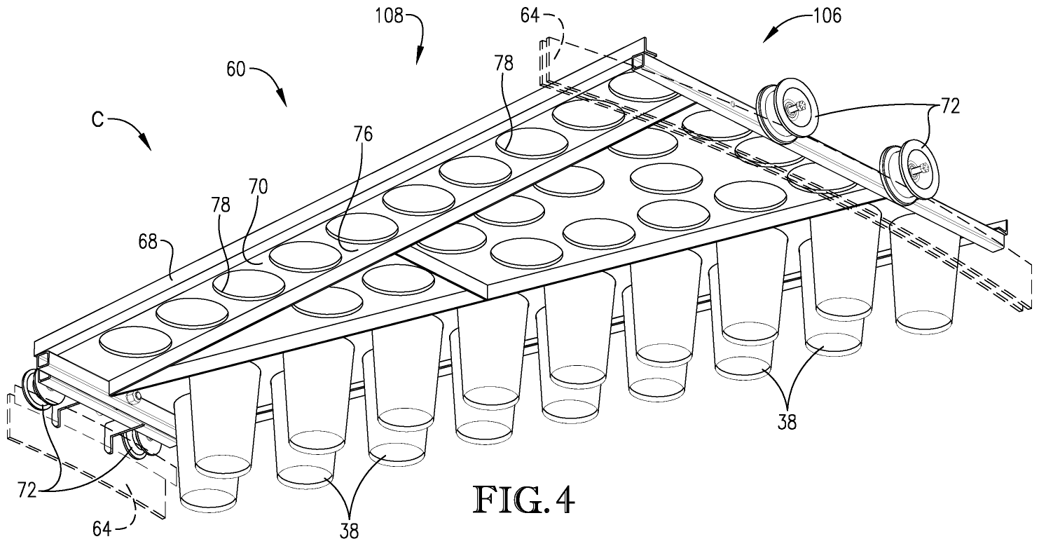

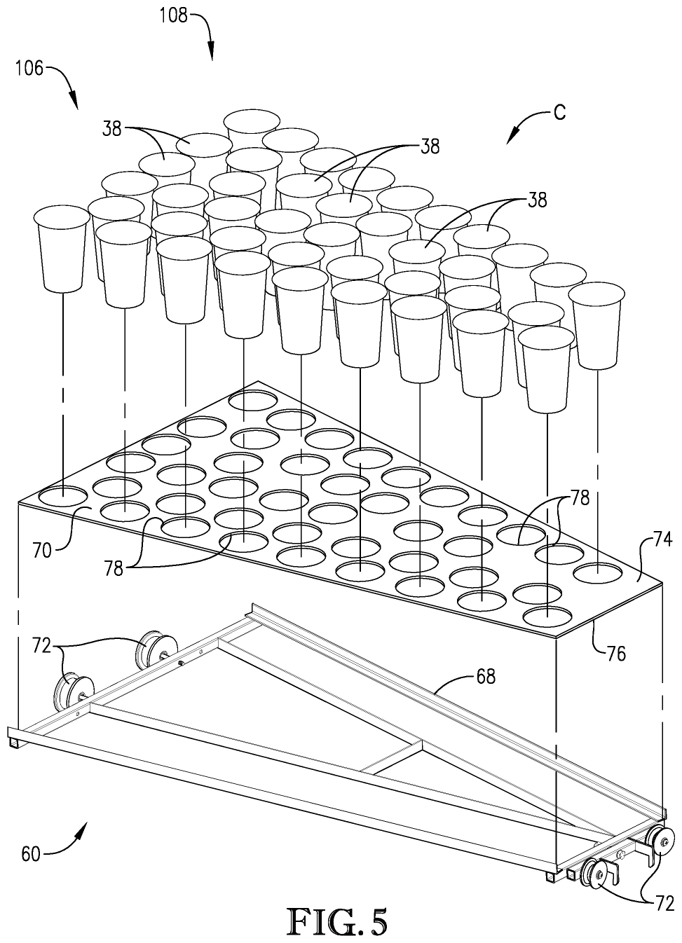

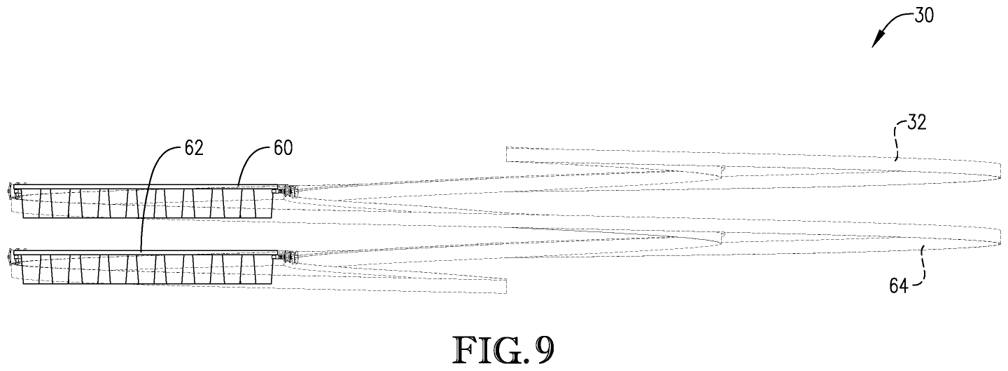

As depicted in FIGS. 3-9 one or more racks or trays are preferably provided as part of movable crop supports 36, which receive disposable containers 38 for holding a mycelium-populated substrate mixture M (see FIG. 8). In the illustrated embodiment, containers 38 hold a mixture M that is colonized with mycelium. However, it will be appreciated that the mixture M may comprise a mixture that is considered to be incubated, inoculated, or is otherwise deemed “ready-to-fruit.”

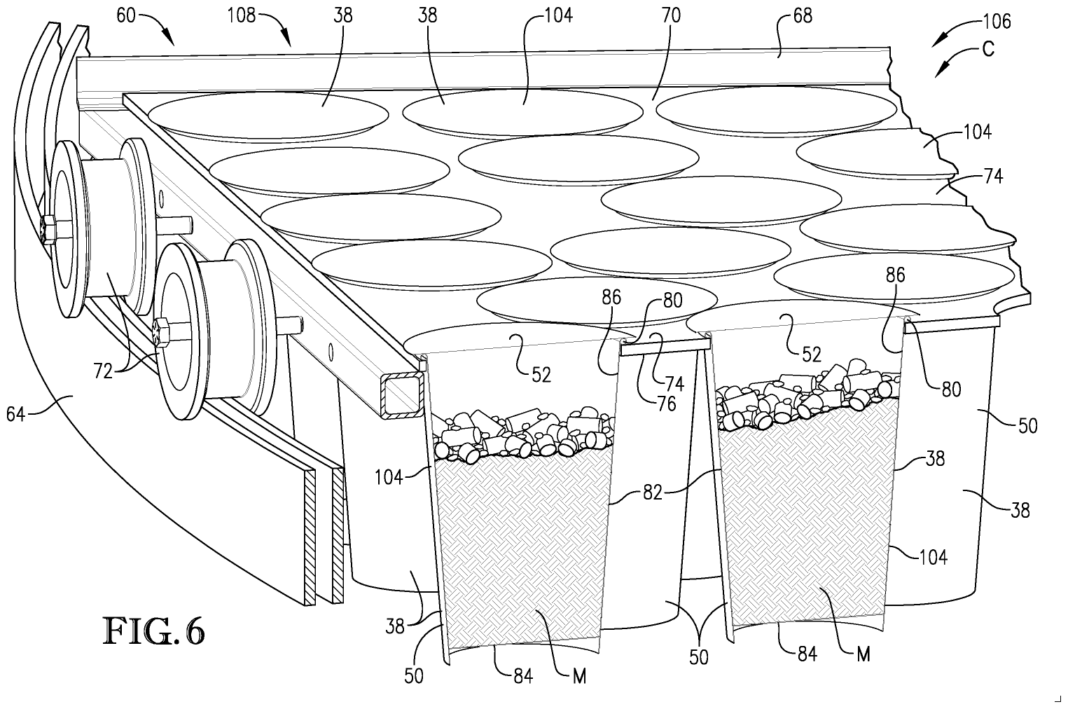

Each of the depicted containers 38 includes an elongated cup 50 and a container cover 52 that includes a filter layer 54 (see FIGS. 6-8). As will be explained, each container 38 is configured to hold the mycelium-colonized substrate mixture M and is sealed with the filter layer 54 to provide a sealed, pre-filled container assembly ready for mushroom production. The container 38 is also preferably constructed to provide an optimal gas exchange rate between the substrate mixture M and ambient.

The movable crop supports 36 each preferably comprise a train 58 with movable carts 60 and a movable control cart 62. The depicted train 58 has adjacent pairs of carts 60,62 that removably contact one another. However, an alternative train may include adjacent pairs of carts that are attached. Carts 60,62 are removably supported on a track 64 and configured to support the crops C. The carts 60,62 are configured to be advanced downwardly along the assembly length to thereby direct the crops C through the growing space 48 along a helix path 66 (see FIG. 2). Preferably, each train 58 includes at least one control cart 62 that controls the speed of advancement of itself and other carts within the train 58. In alternative embodiments, cart advancement is controlled using mechanical restrictions at a series of locations along the track by preferably using, among other things, an electromagnetic device or physical restriction to slow or stop one or more of the carts.

The depicted carts 60,62 are preferably configured for supporting containers 38 and each include a frame 68, a removable tray 70, and wheels 72. Additional features of preferred crop supports are disclosed in the above-incorporated '304 publication.

Each of the illustrated trays 70 is configured to support an array of containers to facilitate commercial-scale mushroom production (e.g., for incubation and fruiting of mushrooms). The depicted tray 70 comprises a unitary rack plate that presents upper and lower planar tray surfaces 74,76 and an array of tray openings 78 that intersect the tray surfaces 74,76 (see FIGS. 3-5). As will be described, the planar configuration of the upper tray surface 74 is configured to vertically align the tops of the containers 38 with one another.

Tray opening 78 preferably defines a plurality of annular tray locating structures attached relative to one another. Such locating structures are spaced horizontally to cooperatively define features of the upper tray surface 74.

The array of tray openings 78 preferably includes multiple rows of openings, with each adjacent pair of openings being laterally offset from one another. Preferably, the rack openings are spaced so that the stored containers are spaced apart from each other. By uniformly spacing adjacent cups apart from each other, the rack enables consistent air flow between the cups during incubation and promotes uniform heat dissipation.

In alternative tray embodiments, the tray may include an alternative number of tray openings and/or one or more tray openings that are alternatively sized. One or more tray openings may also be alternatively arranged relative to one another. The illustrated tray openings are each formed by an endless circular margin of the rack plate. Tray openings are configured so that containers may be removably lowered into respective openings for storage on the tray in a storage position. Similarly, the tray openings permit container removal by lifting the container out of the respective opening. The circular margin of the tray plate structure is configured to engage and support a respective container in the storage position, as discussed in the description appended below. Alternative tray embodiments may include, alternatively or additionally, other structures to engage and hold a container in the storage position. For instance, an alternative tray may include one or more holding elements (e.g., tabs, arms, bosses, etc.) attached relative to the upper tray surface or lower tray surface for engaging and positioning the container in the storage position and may at least partly support the container.

Each tray is preferably formed of one or more rigid and/or semi-rigid materials, such as a metallic material (e.g., carbon steel, stainless steel, aluminum, etc.), a synthetic resin material (e.g., a solid polymer material or a closed-cell polymer foam material), a natural material (e.g., wood), or any combination of such materials.

Containers 38 each present a chamber or interior space to receive the mycelium-colonized substrate mixture M for mushroom production. As described further below, the preferred substrate mixture may include a premixed blend of lignocellulosic material, nutrients, and mushroom growth media “spawn” that are blended prior to hydration. The process of forming the sealed, pre-filled container assembly (including the steps of dispensing substrate and water into the container and sealing the container) is also described below.

Each container 38 preferably includes the elongated paper cup 50, which is entirely disposable and biodegradable. The depicted cup 50 comprises a receptacle with an open mouth or top and includes an uppermost rim 80, a continuous tubular sidewall 82, and a cup bottom 84 that partly define a chamber 86 (see FIGS. 6-8). In the illustrated embodiment, rim 80 preferably provides an upper container element for positioning the container 38 relative to a tray (such as tray 70). The sidewall 82 also defines an endless lower container margin 87 for positioning the container 38 relative to a tray (such as tray 70).

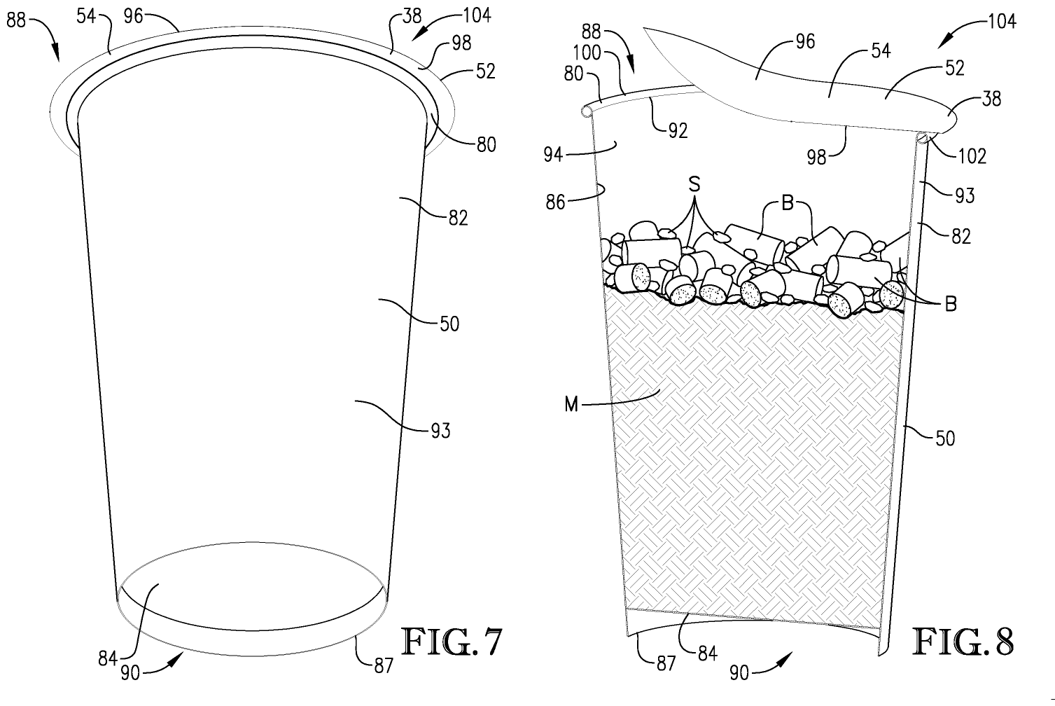

Sidewall 82 extends vertically to present upper and lower ends 88,90, with the cup bottom 84 fixed to the sidewall 82 adjacent the lower end 90. Rim 80 extends along the upper end 88 and defines an open top 92 (see FIG. 8) of the cup 50. Each cup 50 also includes a biodegradable base cup layer 93 and an internal cup lining 94 or coating/film (see FIGS. 7 and 8) that covers the interior cup surfaces and the rim 80.

Although the depicted sidewall shape is generally tubular, the principles of the present invention are applicable for at least certain embodiments where the cup (or an alternative open receptacle) has an alternative structural shape. Alternative cup embodiments may have a tubular body with an alternative tubular shape, such as an alternative angle of taper relative to the tube axis. Also, instead of having a generally circular cross-sectional profile, embodiments of the tubular body may have an alternative cross-sectional profile, such as a polygonal shape (e.g., square, rectangular, hexagonal, etc.). Various embodiments of a cup or other receptacle may also include one or more folds that extend axially along the length of the body (e.g., along a tube axis) and/or about an axis of the body (e.g., about a tube axis). For instance, the cup body may be constructed to provide an optimal gas exchange rate associated with the container.

Each container 38 also preferably includes the container cover 52, which comprises the filter layer 54. The cover 52 and cup 50 cooperatively define and enclose the chamber 86. Filter layer 54 cooperates with the cup 50 to provide a desired gas exchange rate between the substrate mixture M and ambient. In particular, both the sidewall 82 and filter layer 54 are provided with a predetermined permeability or “breathability” to facilitate the desired gas exchange rate. For instance, such permeability may be provided in part by manually forming one or more holes in the sidewall 82 and/or filter layer 54. In preferred embodiments, the cover has a permeability that is greater than or equal to a permeability of the sidewall and/or bottom of the container. Thus, the preferred cover is preferably more breathable or permeable to gas exchange (or as breathable or permeable to gas exchange) than the rest of the container.

Each cup 50 and/or cover 52 may include a biodegradable material layer (e.g., filter paper, copy paper, wax paper, card stock, single layer cardboard, etc.), a synthetic resin fabric material (e.g., a polymer fabric), or any combination thereof. Preferred embodiments of the cup 50 and/or cover 52 may include a material (e.g., a paper and/or board material) that facilitates a desired level of gas exchange between the container chamber and ambient.

Preferred weights of paper and/or board material, associated with the cup and/or cover, may range from about fifty grams per square meter (50 gsm) to about four hundred grams per square meter (400 gsm) and, more preferably, may range from about one hundred grams per square meter (100 gsm) to about three hundred grams per square meter (300 gsm). However, for certain aspects of the present invention, paper and/or board material (or other structural substrate materials) associated with the cup and/or cover may fall outside of these ranges.

It is within the scope of the present invention for the cup and cover to be provided with structural materials (e.g., paper and/or board materials) that are different from one another. For instance, the use of different structural materials in the cup and cover may be suitable for achieving desirable growth conditions. It is also within the ambit of at least certain aspects of the present invention for the cup and cover to include the same structural materials (e.g., paper and/or board materials).

The preferred gas exchange characteristics of the paper and/or board material used, and the water-resistant lining used together as an integrated barrier known as the container, will provide water resistance, limit water vapor loss, limit the rate of CO2 gas exchange and foster some minimal oxygen gas exchange.

Preferably materials are selected so that the inside of the container has minimal water vapor loss to limit the loss of water weight of the container to a range of about zero percent to about four (4) percent by weight over the colonization period. Thus, while the materials have a desired permeability to gas exchange, they are less permeable to water vapors.

Preferably the carbon dioxide transmission rate of the paper and/or board material and the water-resistant lining can be co-operatively controlled by paper and/or board material and lining selection to a concentration of CO2 that preferably ranges from about 5,000 ppm to about 100,000 ppm, and, more preferably, is about 30,000 ppm in the container during fungi colonization. The paper and/or board material type and coating/film type may be attenuated in thickness and material selection to co-operatively meet optimal needs of different varieties of fungi.

The oxygen transmission rate of the paper and/or board material and water proofing lining is not viewed as crucially as CO2 and water vapor loss, but it too can be co-operatively controlled by paper and/or board material and lining selection to co-operatively allow minimal oxygen ingress into the container from ambient to meet the varying needs of different species of obligate aerobic or other fungi.

It will be appreciated that suitable permeability may be developed as a function of cup or filter substrate material properties, lining material properties, cup and/or filter shapes, the ratio of container surface area to chamber volume, cup and/or filter openings, and/or combinations thereof.

While embodiments of the preferred container preferably include a cup and a container cover, it is within the scope of certain aspects of the present invention for an alternative receptacle to be used instead of a cup. Such alternative receptacles may include or be otherwise referred to as a box, block, bag, sack, pan, etc. Alternative receptacles preferably include an open top, although one or more alternative receptacle openings may be provided. An alternative receptacle may have a chamber covered by a cover layer and/or filter layer. Further, an alternative receptacle may or may not have a cover layer and/or filter layer attached thereto. For certain aspects of the present invention, an alternative container may include an elongated channel-shaped receptacle that extends continuously in along a horizontal container axis, along with an elongated filter that extends along the length of the channel structure.

In other embodiments associated with certain aspects of the present invention, it will be appreciated that the cup structure and filter structure may be integrally formed with one another, such that the container has a unitary construction.

The container cover 52 preferably includes a biodegradable base layer 96 and an internal lining 98 (see FIGS. 7 and 8). The lining 98 is applied to the base layer 96 to cover base layer surfaces within the chamber 86.

The internal lining 94,98 of the container 38 cooperates with the paper structure of the container 38 to contain the hydrated mycelium-colonized substrate. This lining 94,98 serves as a water-resistant coating/film that protects the paper structure of the container 38 from exposure to various water sources (such as the hydrated substrate). A preferred container lining preferably comprises a biodegradable material so that the entire container, along with the colonized substrate, is disposable and biodegradable. More preferably, the internal lining includes a biodegradable corn plastic or wax material. For a biodegradable corn plastic coating or film, the coating/film preferably has a coating/film weight that ranges from about twelve grams per square meter (12 gsm) to about one hundred grams per square meter (100 gsm). A more preferred range of coating/film weight may be from about twenty grams per square meter (20 gsm) to about thirty grams per square meter (40 gsm). For at least some aspects of the present invention, more preferred embodiments may have a coating/film weight that ranges from about twenty-five grams per square meter (25 gsm) to about thirty-seven grams per square meter (37 gsm) and, most preferably, the coating/film weight may be about thirty-three grams per square meter (33 gsm). However, it is consistent with certain aspects of the present invention for the coating/film weight to fall outside of one or more of the above-referenced ranges. Varying weights of paper and coating can be used to attenuate the gas exchange and moisture permeability to benefit specific species of cultivated mushrooms.

It is also within the scope of the present invention for alternative containers to include a water-resistant lining or coating/film formed of an alternative biodegradable material or of a material that is not biodegradable. As described below, the internal lining extends along the rim and is configured for sealing engagement with a filter layer.

Preferably, the uppermost rim 80 presents an uppermost container margin 100 (see FIG. 8) that extends about and defines the open top 92, which fluidly communicates with the interior chamber 86. The depicted rim 80 also presents a bottom rim margin 102 (see FIG. 8) that provides an exterior locating surface for engagement with the tray 70. In particular, the rim 80 is sized and configured so that the bottom rim margin 102 engages the circular margin of the tray 70 along the upper tray surface 74 and thereby supports the container 38 in the storage position.

The tubular sidewall 82 of the cup 50 extends continuously from the upper end 88, which is attached to the rim 80, to the lower end 90, which is attached to the cup bottom 84. Preferably, the sidewall 82 comprises a tapered sidewall section that tapers continuously from the upper end 88 to the lower end 90 (see FIGS. 7 and 8). That is, a diameter dimension of the sidewall 82 gradually reduces from the upper end 88 to the lower end 90. In alternative embodiments, at least part of the sidewall may taper in a downward direction (such that the diameter dimension gradually reduces in the downward direction), at least part of the sidewall may taper in an upward direction (such that the diameter dimension gradually reduces in the upward direction), and/or at least part of the sidewall may have a constant diameter.

The tapered shape of the sidewall 82 preferably permits the cup 50 to be easily inserted through the tray opening 78 (e.g., for locating the cup 50 in the storage position) and removed from the tray opening 78, while minimizing inadvertent contact between the cup 50 and the circular margin of the tray 70 during insertion and removal. Preferably, the upper end of the sidewall 82 presents an outermost diameter that is inboard of the rim 80 and is slightly smaller than the tray opening diameter, such that the circular margin and container 38 define a small gap that extends around at least part of the container 38 in the storage position. However, the sidewall 82 and circular margin may contact one another in the storage position (e.g., where the circular margin contacts the sidewall 82 along the entire sidewall circumference or along only part of the sidewall circumference). The tapered cup shape also enables suitable spacing between adjacent cups 50, which facilitates consistent air flow between the cups 50 during incubation and promotes uniform heat dissipation. Again, the planar configuration of the upper tray surface 74 is preferably configured to vertically align the tops of the containers 38 with one another. For the depicted embodiment, the rims 80 of the containers 38 have a uniform rim thickness and engage the planar tray surface 74 in the stored position. Consequently, for containers 38 located in the stored position, the uppermost container margins 100 of the containers 38 are substantially coplanar with one another. Even where the containers 38 have inconsistent container heights, this container support arrangement permits consistent vertical positioning of the container tops.

Although the depicted rim 80 provides the exterior locating surface for uniform vertical positioning of the container tops, alternative container embodiments may have one or more alternative structural support elements for engaging the tray 70 and positioning the container 38 relative to the tray 70. For instance, alternative containers may have a support element (e.g., a ridge, tab, groove, shoulder, etc.) spaced between the upper and lower ends of the sidewall.

In use, the container 38 is filled with a mixture M of spawn S and sanitized substrate B to provide a sealed, pre-filled container 104 (see FIGS. 6-8). One or more trays 70 may be configured to receive multiple containers, whether the containers comprise pre-filled containers 104, containers 38, or other containers. The illustrated tray 70 and containers 38 cooperatively provide a container assembly 106 for the growing system 30.

Each cart 60,62 is operable to receive at least one tray 70 and one or more containers, such that the cart 60,62, tray 70, and container(s) cooperatively provide a mobile cart assembly 108 for growing crops C.

Each sealed, pre-filled container 104 is configured to be prepared for production by sanitizing the container 38, dispensing a premixed and sanitized substrate B into the container while also dispensing a measured amount of spawn S to mix with substrate B preferably evenly or with a bias of more spawn S towards the top, hydrating the substrate and spawn mixture M, and sealing the filter layer 54 onto the container top. Initially, prior to introduction of the substrate into a container, the empty container 38 is preferably irradiated with a UV germicidal light to sanitize the container, particularly the interior lining. Additionally, the filter layer may be disinfected (preferably irradiated by UV light) on inner and outer surfaces.

Again, the substrate preferably includes a premixed blend of lignocellulosic material (e.g., sawdust) with nutrients. Spawn is preferably blended and dispensed into the container prior to hydration. Preferably, the spawn is dispensed simultaneously with the substrate at a controllable ratio. Substrate nutrients may include various types of mushroom supplements and/or minerals.

In preferred embodiments, the sawdust and nutrient components may be premixed and provided in the form of compressed pellets that are pre-pasteurized (that is, prior to mixing of the pellets with spawn and substrate hydration). In particular, pellets are pasteurized and sanitized via heat and pressure generated during a pellet forming process. Additional disinfection of pellets may be done after pellet formation. Dry sterilization of pellets is particularly beneficial for enabling the use of disposable cup containers for mushroom production. It has also been found that pre-sterilization of the substrate components, particularly via dry sterilization, is substantially more energy efficient compared to conventional substrate sterilization methods (such as steam treatment).

Premixed pellets and spawn of the preferred mixture M are preferably introduced to and mixed in the container 38 prior to substrate hydration. Predetermined amounts of pellets and spawn may be dispensed into the container 38 manually or by machine. For instance, pellets and spawn may be drawn from one or more hoppers, conveyed via an auger, and dispensed into multiple containers 38. The pellets and spawn may be mixed with each other while being conveyed and/or dispensed into the container 38. In preferred system embodiments, pellets and spawn may be conveyed by separate augers. Each auger may be driven by an electric motor that is operably coupled to a processor or other controller to control the auger rotational speed and/or timing of auger rotation. Preferably, pellets and spawn are each conveyed by a respective auger and at a calibrated rate so that predetermined amounts of pellets and spawn may be dispensed into each of multiple cups (e.g., via an automated process). In preferred embodiments, the process of dispensing pellets and spawn into the container 38 may be configured so that the amounts of spawn dispensed with the pellets changes along the container height. The preferred process includes co-dispensing of pellets and spawn, with pellets and spawn being dispensed simultaneously during at least part of the dispensing process to produce a mixed layer of pellets and spawn (the mixed layer may be referred to as “through spawning”). Also, during the dispensing process, the rate of spawn discharge may increase, decrease, and/or stay constant. For instance, during at least part of the process, spawn may be dispensed at a rate of discharge that increases as the container is being filled, such that the concentration of spawn in the container increases in a vertical direction. Similarly, during at least part of the process, spawn may be dispensed at a rate of discharge that decreases as the container is being filled, such that the concentration of spawn decreases in the vertical direction. Any change in spawn rate of discharge (e.g., increase and/or decrease) may include a discrete rate change (such as a discrete rate increase or decrease) and/or a progressive rate change (such as a progressively increasing rate or decreasing rate). It will also be understood that the rate of pellet discharge may increase, decrease, and/or stay constant during the dispensing process.

Although the process of dispensing substrate pellets and spawn into the container includes simultaneous dispensing of both pellets and spawn, the dispensing process may include at least one step where pellets are dispensed without dispensing spawn and/or at least one step where spawn is dispensed without dispensing pellets. For instance, the dispensing process may include dispensing a layer of pellets into the container, such as a bottom pellet layer dispensed into the bottom of the container. Similarly, the dispensing process may include dispensing a layer of spawn into the container, such as an uppermost layer of spawn (which may be referred to as a “top spawn”). It will be appreciated that embodiments of the dispensing process may be configured to form multiple, vertically-stacked layers of pellets and/or spawn, with each layer having pellets, spawn, or a combination of pellets and spawn. The disclosed process of dispensing pellets and spawn has been found to simplify production of pre-filled container assemblies, minimize (or eliminate) the need for separate mixing of substrate and spawn, reduce colonization time, and protect against competitor organisms.

Once the premixed blend of pellets and spawn are introduced to the container, the substrate may be dosed with a predetermined amount of sterilized water. Water may be dispensed into the container manually or by machine (e.g., via an automated process). Preferably, water may be sterilized inline prior to dispensing into the containers to ensure by methods which may include UV sterilization, chlorine dioxide, hydrogen peroxide, ozonation or other common water sterilization methods. Preferably, the water is treated with minerals or other aqueous or water soluble nutrients and agitated into solution. Mineral enhancement traditionally requires sterilization processes that are post processing steps whereas this method allows sterilization inline prior to mineralized or nutrified water is dispensed.

It has been found that the disclosed process of dispensing a blend of premixed pellets with spawn into the container and hydrating the blended pellets and spawn in the container is beneficial, particularly for reducing labor and facilitating machine preparation of the containers.

Following hydration of the mixture M, the cup 50 of container 38 is preferably covered with a respective filter layer 54 by sealing the filter layer 54 to the rim 80. The illustrated filter layer 54 comprises a permeable layer configured to removably cover the top of a respective cup 50 and permit the flow of gas and moisture into and/or out of the container 38. In other words, the depicted filter layer provides an individual filter configuration for removable covering of a single container supported on the tray. As will be discussed, filter layer is preferably sealed to the rim of container 38 located on the tray (e.g., by adhesive sealing or heat sealing). The individual filter layer is preferably provided in the form of a unitary filter structure with a perimeter shape that generally conforms to the shape of the cup rim 80. However, for some aspects of the present invention, filter layer may be differently shaped compared to the cup rim.

In other preferred embodiments, the filter layer may comprise a “batch cover” filter configuration for removable covering of multiple containers supported on the tray. Such an alternative filter layer is preferably sealed to the tops of containers located on the tray (e.g., by adhesive sealing or heat sealing). The batch cover filter layer is preferably provided in the form of a unitary filter structure with a perimeter shape that generally conforms to the shape of the tray. For instance, the batch cover filter layer and tray may present similarly sized rectangular shapes and may be configured to be arranged in overlapping registration with one another. However, for some aspects of the present invention, filter layer may be differently shaped compared to the tray.

Filter layer 54 comprises a breathable filter that engages and seals against the cup rim 80 while permitting the flow of gas and moisture into and/or out of a chamber of the container 38. In at least some embodiments, the filter layer may be heat sealed or adhesively sealed to the container tops. For instance, the container lining, which is coated onto the container rim, is configured for heat sealing the filter layer to the container rim. During the heat-sealing process, the filter layer (whether in the form of a batch cover filter or individual filter) is applied to the container top(s) and in the case of individual filter, heat is applied to melt the rim coating/film and thereby seal the filter to the rim.

The filter layer 54 may be applied and/or sealed on top of the containers either manually or using a machine (e.g., via an automated covering and/or sealing process). Similarly, the filter layer may be removed from the containers manually or using a machine (e.g., via an automated uncovering process). To initiate the fruiting response of mycelium in the substrate, slits or holes may be formed in the filter layer at locations aligned with the container openings. This process may also be done manually or with a machine. Filter material is preferably configured to restrict microorganisms (such as mold spores or bacterial endospores) and/or other contaminants from accessing the container interior and the mycelium-colonized substrate via the container opening. The filter layer may be configured with specific thicknesses of paper or media which may include laminated coating(s)/film(s) of specific thickness and varying hydrophobic properties to allow specific gas exchange and moisture permeability between the external environment and the interior of the container based on which fungi strain is being cultivated. Preferably, the filter layer may include materials such as Polylactic acid (PLA), Polyethylene (PE), compostable waxes, other polymers/biopolymers, and/or other materials, for achieving suitable gas exchange and/or permeability properties. Although filter layer preferably comprises a structure that is compostable and/or biodegradable, at least certain aspects of the present invention may contemplate a filter layer with at least some materials or portions that are not compostable or biodegradable.

Preferably, filter layer 54 comprises a porous and breathable filter material. In preferred embodiments, the filter material is generally operable to filter microorganisms and airborne particulates that range in size from about two-tenths (0.2) of a micron to about two (2) microns. Embodiments of the filter layer may include a biodegradable material layer (e.g., filter paper, copy paper, wax paper, card stock, single layer cardboard, etc.), a synthetic resin fabric material (e.g., a polymer fabric), or any combination thereof. Preferably, the filter layer comprises a biodegradable material so that the filter layer, container, and substrate are disposable and biodegradable. For at least some embodiments, containers may use a filter layer that is not biodegradable. For instance, the filter layer(s) may be removed from the container(s) after use (e.g., where the batch cover filter is removed from the containers supported on the rack). A non-biodegradable filter material may comprise high-density polyethylene filaments (such as a Tyvek® filter material), polypropylene filaments (such as a Typar® filter material), and/or other polymer filaments.

In alternative embodiments, an impermeable cover layer may be provided over the filter layer to hold the filter layer in sealing engagement with the rim of the cup. Such a cover layer preferably overlies the filter layer and containers and is operable to control the filtered area associated with each container. Cover layer is preferably provided in the form of a unitary, weighted cover structure with a perimeter shape that generally conforms to the shape of the rack and filter layer.

Embodiments of the cover layer may include an array of cover openings arranged and spaced to overlie respective tray openings and the corresponding container openings. Preferably, each cover opening is aligned with and at least partly overlaps a corresponding container opening. More preferably, each cover opening is generally coaxially aligned with the corresponding container opening.

Cover openings each present a cover opening diameter that is calibrated to control the rate of gas exchange between each container and the ambient space outside the container. As discussed in the description appended below, the cover opening area and rate of gas exchange may be selected in accordance with the species of mushroom produced. In preferred embodiments, each cover opening has a cover opening diameter that is smaller than a container opening diameter of the container. In this manner, the cover opening area defined by the cover opening determines the effective filter area associated with the container. It will be appreciated that multiple cover layers may be provided with different cover opening configurations (e.g., different cover opening diameters) to provide corresponding rates of gas exchange. Additional features of a preferred cover layer are disclosed in the above-incorporated '304 publication.

The cover layer is preferably formed of one or more non-porous rigid and/or semi-rigid materials. Embodiments of the cover layer may include a metallic material (e.g., carbon steel, stainless steel, aluminum, etc.), a synthetic resin material (e.g., a solid polymer material), a natural material (e.g., wood), or any combination of such materials. As populated containers 38 are advanced downwardly through the silo 40, it will be appreciated that the mycelium may be inoculated and then colonized/incubated prior to reaching the bottom of the silo 40 and being readied for shipment. However, for at least certain aspects of the present invention, the mycelium may only be inoculated prior to being shipped. Alternatively, it is also within the scope of certain aspects of the present invention, for the container to be fully colonized at an intermediate location between the top and bottom of the silo. In such embodiments, a portion of the silo may be configured with a “fruiting” section for producing a mushroom fruit body as the container is advanced from the intermediate location to the bottom of the silo. The fruiting section of the silo may also be used to facilitate harvesting of mushroom fruit from the container.

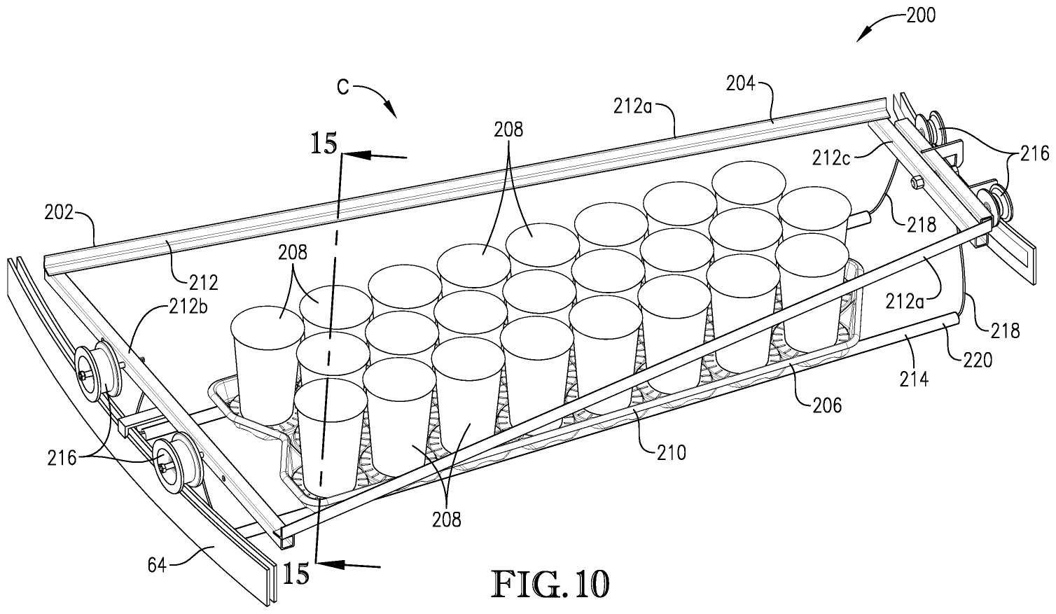

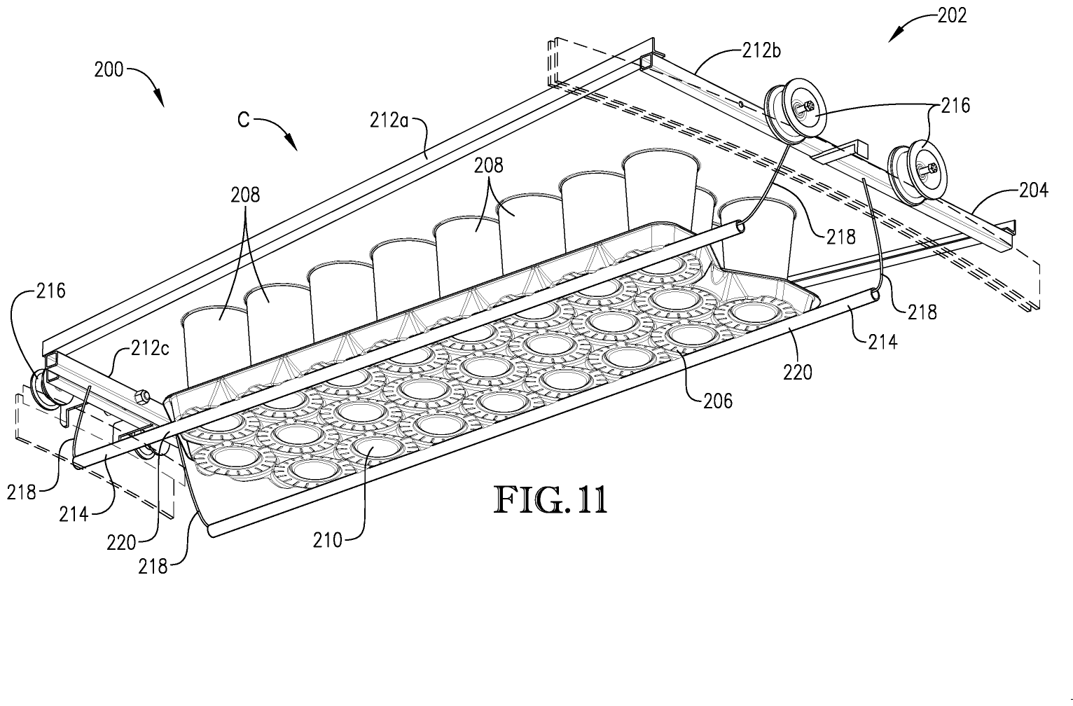

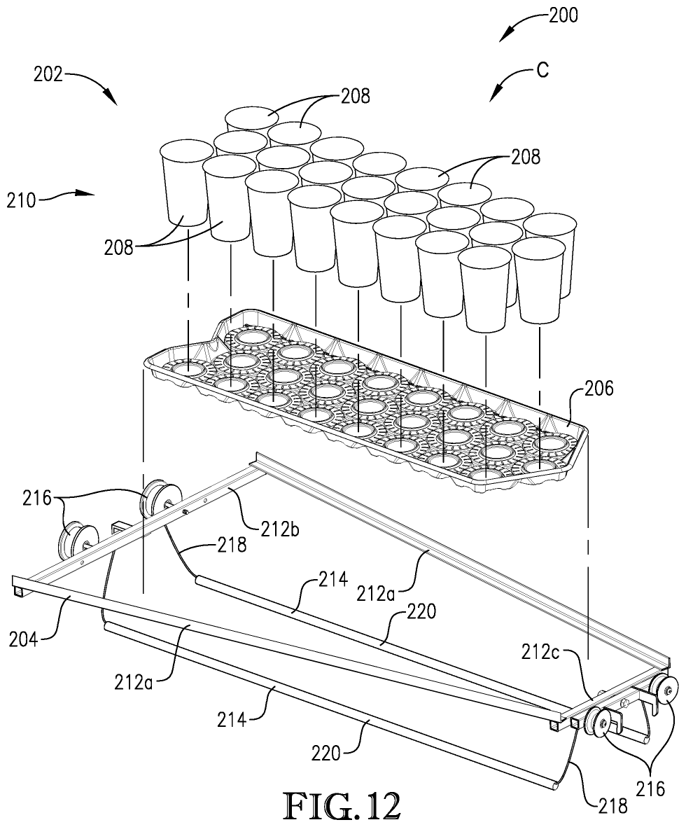

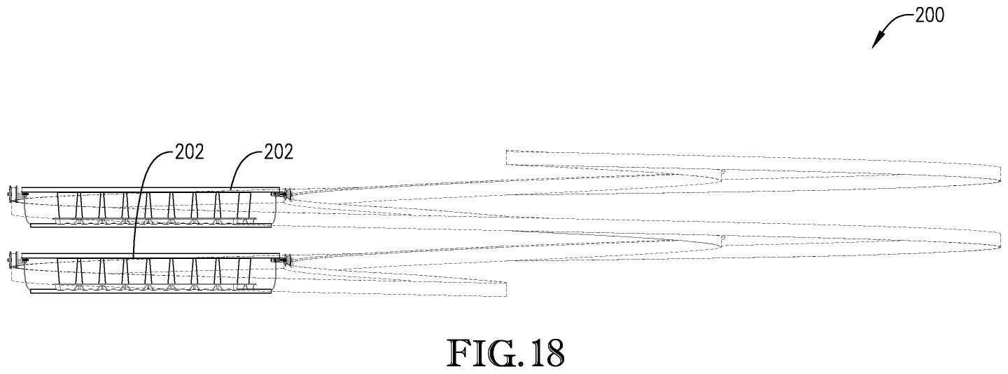

Turning to FIGS. 10-23, alternative preferred embodiments of the present invention are depicted. For the sake of brevity, the remaining description will focus primarily on the differences of these alternative embodiments from the preferred embodiment described above.

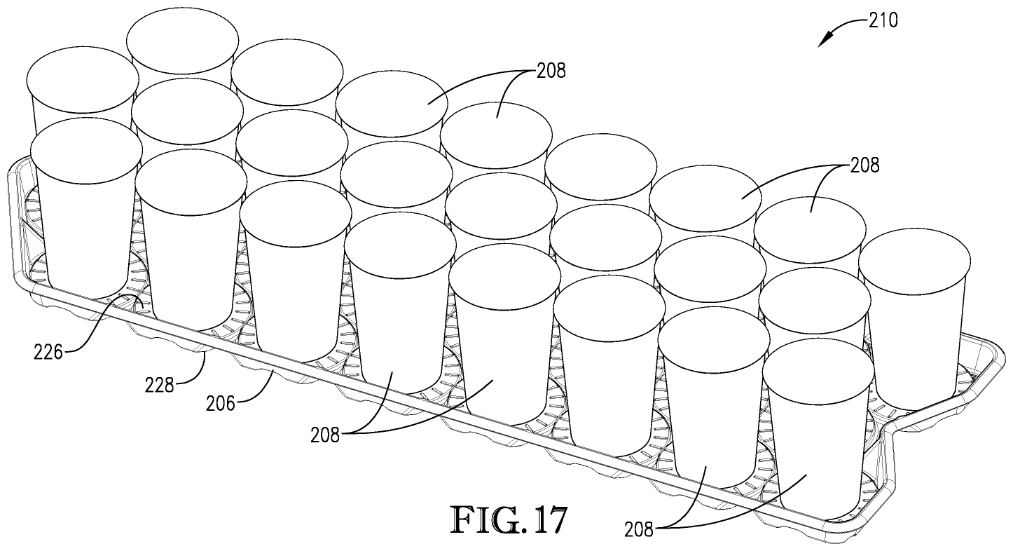

Initially turning to FIGS. 10-18, an alternative growing system 200 is constructed in accordance with a second embodiment of the present invention and comprises an alternative mobile cart assembly 202. The depicted cart assembly 202 includes a cart 204 (which includes a removable supporting tray 206), and containers 208 for growing crops C. Tray 206 and containers 208 cooperatively provide a container assembly 210 (see FIG. 17) for the growing system 200.

Cart 202 broadly includes a frame 212, suspended supports 214, the supporting tray 206, and wheels 216. Frame 212 includes a pair of longitudinal supports 212a and cross members 212b,212c. The suspended supports 214 each include an elongated, flexible tension member 218 and a tubular member 220 that slidably receives the tension member 218.

Tension member 218 is fixed at opposite ends to respective cross members 212b,212c. Embodiments of the tension member 218 may include a braided rope, wire, wire rope, etc. The flexibility of tension member 218 permits adjustable positioning of the support 214 relative to the frame 212 of tray 206. Tubular member 220 includes an elongated tube that is preferably rigid and is configured to engage a lower surface of the tray 206.

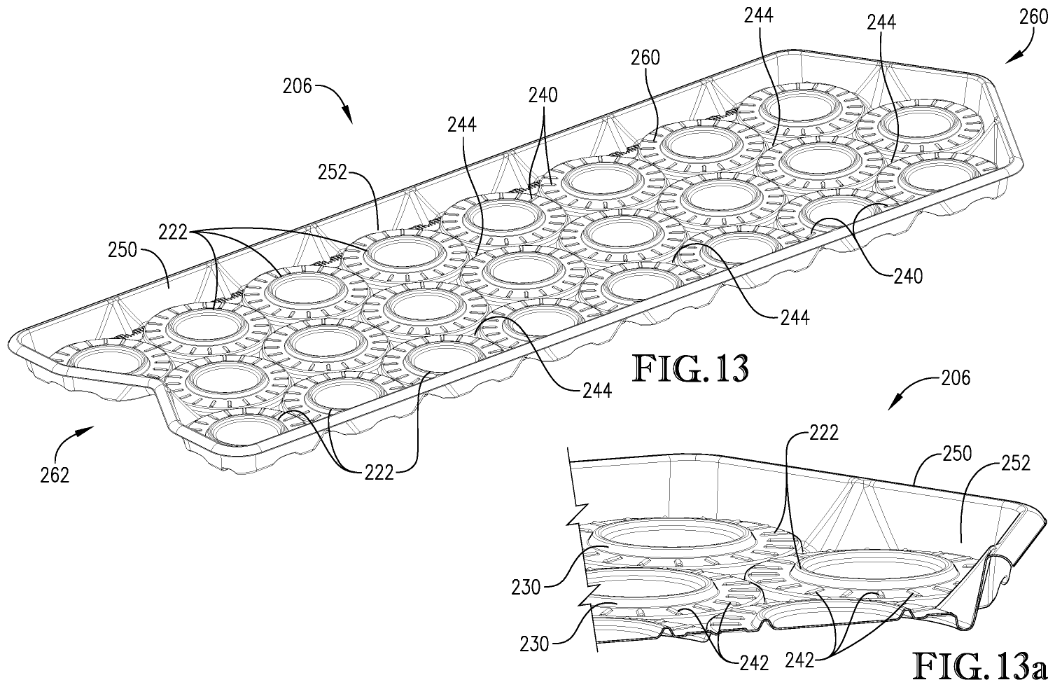

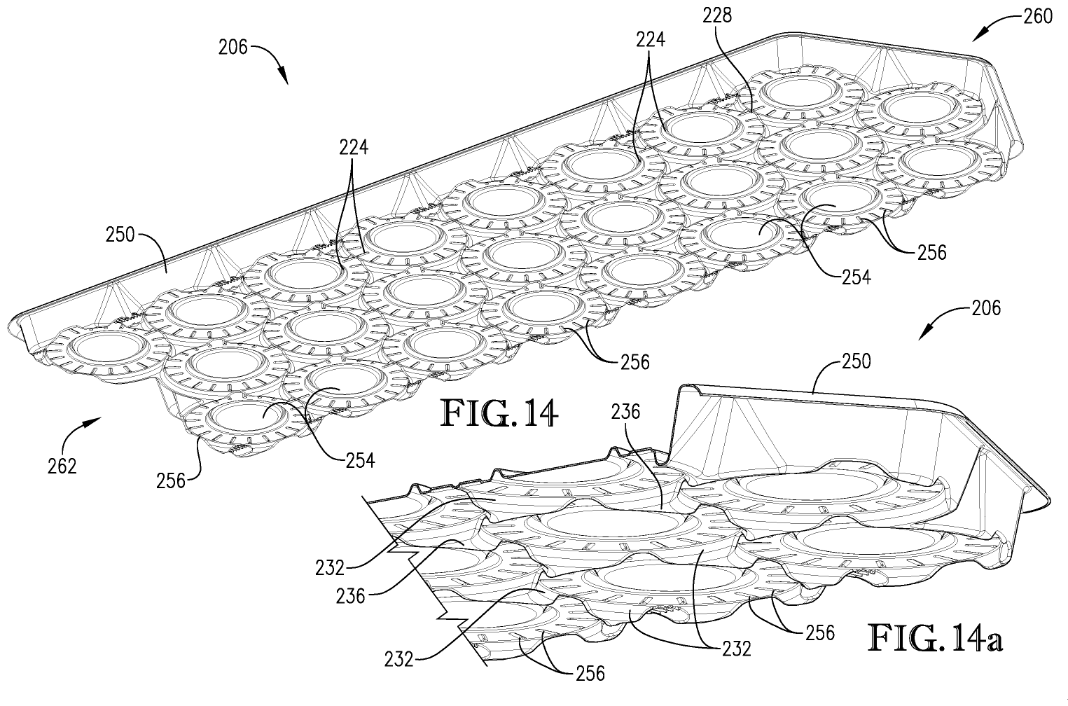

Turning to FIGS. 13-14a and 16, each of the illustrated trays 206 is configured to support an array of containers to facilitate commercial-scale mushroom production (e.g., for incubation and fruiting of mushrooms). The depicted tray 206 has a unitary construction and includes a plurality of upper tray locating structures 222 (see FIGS. 13 and 13a) and a plurality of lower tray locating structures 224 (see FIGS. 14 and 14a). The upper and lower tray locating structures 222,224 each have a generally circular shape, are attached relative to one another, and are spaced horizontally to at least partly define respective upper and lower tray surfaces 226,228.

In the illustrated embodiment, the upper tray locating structures 222 each present an upper shoulder 230 (see FIG. 13a) that forms part of the upper tray surface 226 and is configured to locate the lower container element of a respective container 38. The lower tray locating structures 224 each present a lower shoulder 232 (see FIG. 14a) that forms part of the lower tray surface 228 and is configured to locate the upper container element of a corresponding container 38.

Preferably, upper and lower shoulders 230,232 are horizontally aligned with each other so that containers 38 may be vertically stacked and at least partly overlap one another. More preferably, the upper and lower shoulders 230,232 are coaxially aligned with one another.

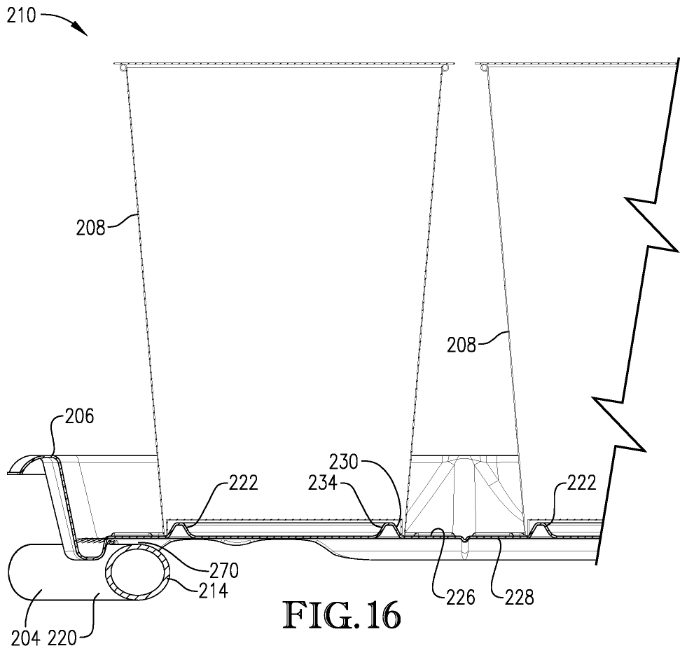

In the illustrated embodiment, upper tray locating structures 222 preferably include an arcuate upper ridge 234 (see FIGS. 13a and 16) that defines the upper shoulder 230 and an arcuate lower ridge 236 or projection (see FIG. 14a) that defines the lower shoulder 232.

The upper shoulder 230 of the upper ridge 234 preferably has a smaller diameter dimension than the lower shoulder 232 of the lower ridge 236. Furthermore, in the depicted embodiment, upper shoulder 230 comprises a male locating structure and the lower shoulder 232 comprises a female locating structure. Upper tray locating structures 222 comprise discrete platform surfaces 240 spaced apart from one another to receive the base of respective containers 38 (see FIG. 13). The illustrated platform surfaces 240 have an arcuate shape and surround corresponding ones of the upper ridges 234. Platform surfaces 240 also present a series of radially-extending grooves 242 (see FIG. 13a) that permit fluid flow below the base of respective containers.

The tray 206 also includes a plurality of recessed areas 244 (see FIG. 13) that separate adjacent upper tray locating structures 222. Preferably, recessed areas 244 form part of the upper tray surface 226 and are spaced below the upper tray locating structures 222.

Preferably, the upper tray locating structures 222 are integrally formed with the lower tray locating structures 224, so that the tray 206 has a unitary construction. However, it is within the ambit of certain aspects of the present invention for upper and lower tray locating structures to be provided as part of respective tray sections that are not integrally formed with one another.

The depicted tray 206 also preferably includes an endless rim 250 that surrounds the upper and lower tray locating structures 222,224 and at least partly defines a channel 252 (see FIG. 13a) extending below the upper tray locating structures 222.

Lower tray locating structures 224 comprise discrete covering surfaces 254 (see FIG. 14) spaced apart from one another to receive the rim 80 of corresponding containers 38. Each covering surface 254 presents a series of radially-extending grooves or passages 256 to permit fluid flow into and out of corresponding containers 38.

In the depicted embodiment, the covering surfaces 254 are preferably defined by an impermeable tray covering wall that engages the rim 80 and restricts fluid flow into and out of the containers 38. It is also within the scope of certain aspects of the present invention for the covering wall to include a permeable filter element that permits fluid flow into and out of containers. It will be appreciated that such a filter element may be used in addition to or alternatively to the depicted filter layer 54. For example, in at least some embodiments, a tray may include a tray filter configured and positioned to cover a plurality of containers, such that the tray provides a “batch” filter. The tray filter may include one or more filter elements, with each filter element associated with one or more respective containers.

The illustrated tray also preferably presents opposite forward and aft tray ends 260,262 and defines a longitudinal tray axis A. Preferably, forward tray end 260 comprises a male end and the aft tray end 262 comprises a female end configured to receive and engage the male end of another tray 206. In this manner, an engaged pair of tray ends 260,262 associated with adjacent trays 206 are configured to cooperatively restrict relative off-axis movement between the adjacent trays 206.

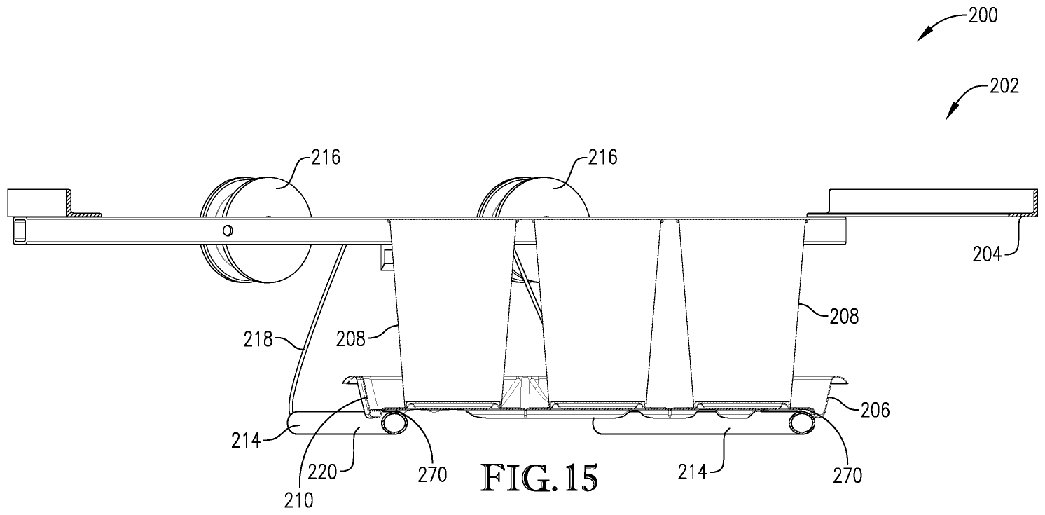

Trays 206 also preferably present pairs of lower scalloped surfaces 270 that removably receive and engage respective supports 214 of the cart 204 (see FIGS. 15 and 16). In alternative embodiments, a tray 206 may be supported on a conveyor mechanism that engages the surfaces 270. For instance, embodiments of the conveyor mechanism may include a pair of elongated threaded rods that are parallel with one another and extend along a conveyor axis. The threaded rods are preferably engaged with respective surfaces 270 at locations along the conveyor axis. By rotating the threaded rods at the same, the threaded rods are configured to cooperatively advance the tray 206 along the conveyor axis. It will be appreciated that the threaded rods may be manually driven or may be driven by a powered motor (e.g., an electrical or pneumatic motor).

Although not depicted, it will also be appreciated that trays 206 are preferably nestable with one another to provide compact stacking and transportation of a group of trays 206. When a pair of trays are nested with each other, an upper one of the trays is inserted into an open top of a lower one of the trays. In this manner, part of the upper tray extends below the rim of the lower tray.

Trays may be constructed of various materials that provide the tray with suitable strength and/or weight characteristics. Materials suitable for forming various features of the trays may include metallic materials (e.g., aluminum, carbon steel, stainless steel, etc.), synthetic resins (e.g., polymers), wood, paper, or combinations thereof.

The disclosed system of trays and containers includes features that provide numerous advantages. For instance, containers may be carried or conveyed in a batch of cups supported on a single tray. Although the depicted trays 206 include locations to carry up to twenty-four (24) containers, alternative tray embodiments may be configured to support an alternative number of containers. The tray locating structure 222 features a natural raised ridge to fit just inside the recessed concave base of a cup to both position the cup in a specific location on the tray and also to reduce tendency to tip while being moved. Trays can be made with a variety of food safe plastics or by pressing stainless steel or aluminum to form a rigid assembly capable of carrying the weight of the cup products.

An additional feature of the trays is a cylindrical indentation formed into the geometry under the trays for supporting the trays with supporting rods or vertical cut patterns made of rigid plastic or metal or other high strength supporting material. The trays may be placed on shelving or on a mobile cart for the helix application. The spacing of the cups is geometrical repeatable and regular to allow thorough air circulation to convectively cool the cups.

Another advantage provided by aspects of the invention is that the trays are nestable for efficient stacking and transport.

An additional benefit of the tray system is that containers may be placed on the trays by mechanical means due to their regular shape suitable for automation. The trays may then provide a means by which workers or customers handle the product. This construction has been found to minimize (or even eliminate) the need for humans to touch the cups throughout the entire process.

The disclosed tray system provides a further benefit of facilitating a batch composting process. Once harvesting is completed, the tray may be dumped into a composting process whereby the substrate, container and filter layer may be shredded and conveyed without the need for individual container handling.

A further benefit of the tray system is the arrangement of a high density of containers on a conveyor or shelf surface whereby container locations may be controlled and high density may be achieved. The height of all mushrooms supported by containers may vary only by the manufacturing tolerance of the cups which may be within 1/16″ of an inch or smaller. The small variation of the height of the dividing line between harvestable product and container is regular. For example, in instances where a batch of containers supported on one or more trays are taken through a fruiting and/or harvesting process, the disclosed tray system allows mechanical harvesting blades, water jet, or ultrasonic frequency vibratory knife to be used to separate the mushroom fruit bodies from the cup. Alternatively, as discussed above, it will be appreciated that the tray system may be used in a process to produce an end product in the form of a “ready-to-fruit” pre-filled container, and the disclosed tray system may or may not be subsequently used for fruiting or harvesting of the containers. Thus, the disclosed tray system may be beneficially utilized for one or more process steps associated with producing “ready-to-fruit” containers, fruiting containers, and/or harvesting fruited containers and may include the steps of populating the containers with mycelium and/or substrate, container inoculation, partial colonization, full colonization, partial incubation, full incubation, fruiting, harvesting, and/or other process steps. Moreover, it will be appreciated that the disclosed tray system has been found to provide any of the above-referenced process steps with various advantages including, but not limited to, enhanced convenience and efficiency.

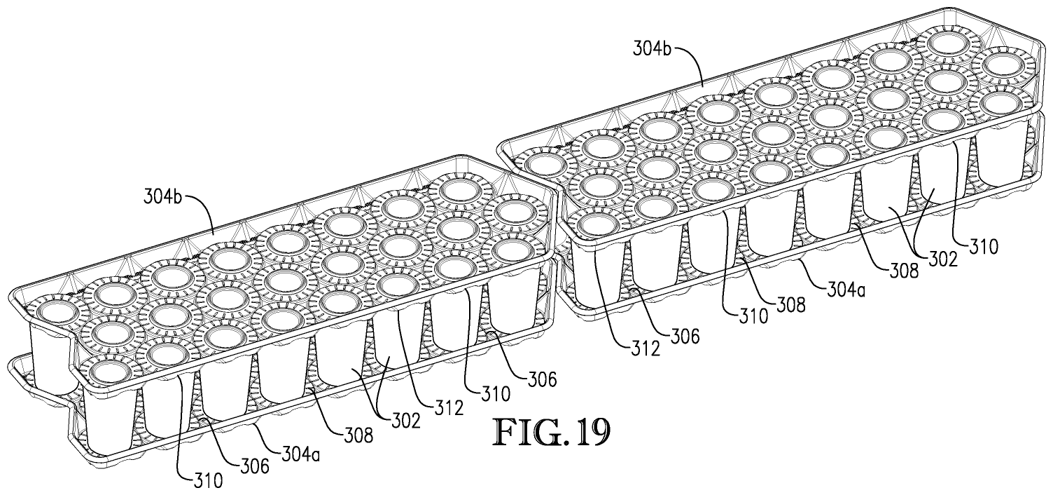

Referring to FIG. 19, a container assembly 300 is constructed in accordance with a third embodiment of the present invention and is configured to permit stacking of multiple layers of containers 302 and trays 304. The illustrated containers 302 are similar in construction to containers 38 and 208 described in the previous embodiments. Trays 304 are similar in construction to trays 206 in the prior embodiment. In the depicted embodiment, container assembly 300 includes a supporting tray 304a, a covering tray 304b, and a series of containers 302 cooperatively held by the trays 304a,304b. The tray 206a304a includes a plurality of upper tray locating structures 306 attached relative to one another and spaced horizontally to cooperatively define the upper supporting tray surface 308 of the supporting tray 304a. The covering tray 304b includes a plurality of lower tray locating structures 310 attached relative to one another and spaced horizontally to cooperatively define the lower covering tray surface 312 of the covering tray 304b. The upper tray locating structures 306 of the supporting tray 304a are removably associated with respective lower tray locating structures 310 of the covering tray 304b to cooperatively engage the containers 302 therebetween. In preferred embodiments, each pair of upper and lower tray locating structures 306,310 that cooperatively engage a container 302 are preferably coaxially aligned with one another. However, alternative embodiments of the container assembly may include pairs of tray locating structures that are off-axis but still configured to engage respective containers.

Thus, the depicted assembly 300 is configured to provide advantageous stacking of trays and containers. The covering tray 206 may be placed in a manner that has the tray bottom resting on the top rims of the containers beneath them. The conforming preferably circular indentation of the trays 206 matches the cup and sealed filter assembly to retain the container in an upright orientation.

In particular, upper shoulders (not shown) of the supporting tray 304a are configured to locate the lower ends of respective containers 38. Lower shoulders (not shown) of the covering tray 304b are configured to locate the rims of corresponding container 38. The illustrated trays 304a,304b are configured and positioned so that upper shoulders of the supporting tray 304a are aligned with respective lower shoulders of the covering tray 304b. In this manner, respective pairs of shoulders cooperatively engage corresponding containers 302.

The illustrated trays 304a,304b are substantially identically constructed and preferably comprise dual-use trays that are interchangeable with one another. It will also be appreciated that alternative embodiments of the container assembly may include supporting trays and covering trays that are different from one another. The use of interchangeable trays 304 permits stacking of multiple layers of trays 304 and containers 302. Although a single layer of containers 302 is depicted between adjacent trays 304a,304b, it will be understood that a second layer of containers 302 may be positioned on upper tray locating structures 306 of the covering tray 304b. A second covering tray (not shown) may then be positioned on the second layer of containers 302, with lower tray locating structures 310 of the second covering tray engaging the rims of the second layer of containers. In like fashion, one or more additional layers of containers may be further stacked above the second covering tray, with adjacent container layers being separated by a respective tray. It has been found that trays 304 and one or more layers of containers 302 stacked between adjacent trays 304 cooperatively interlock with each other and provide a light, rigid support structure capable of supporting a significant weight.

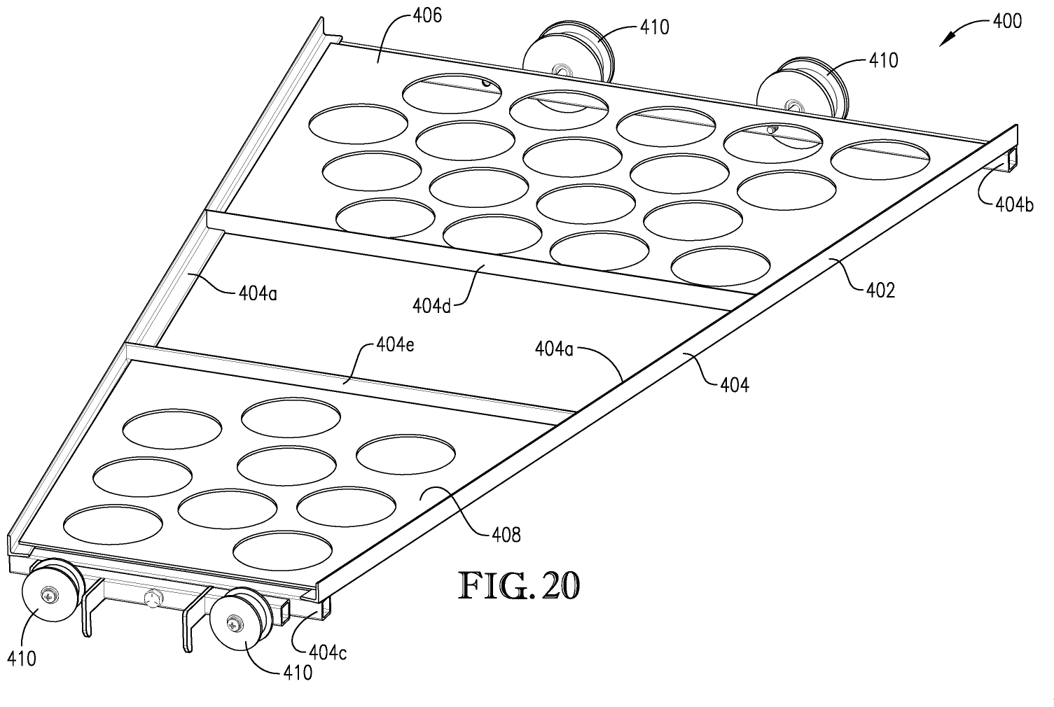

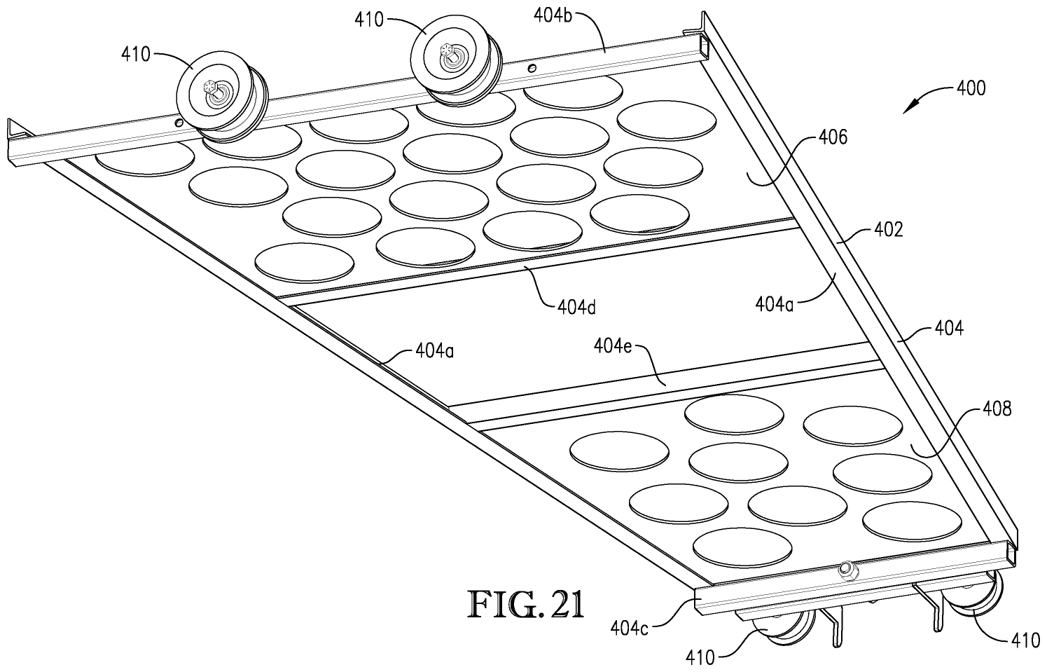

Turning to FIGS. 20 and 21, an alternative growing system 400 is constructed in accordance with a third embodiment of the present invention and includes a cart 402 configured to support containers as part of an alternative growing assembly. The depicted cart 402 broadly includes a frame 404, a pair of removable supporting trays 406,408, and wheels 410.

Frame 404 includes a pair of longitudinal supports 404a, endmost cross members 404b,404c, and intermediate cross members 404d,404e. Cross members 404b,404d cooperatively support the tray 406, while cross members 404c,404e cooperatively support the tray 408. It will be appreciated that trays 406,408 may be selectively positioned on the frame 404 or removed from the frame 404 to facilitate container movement during the growing process.

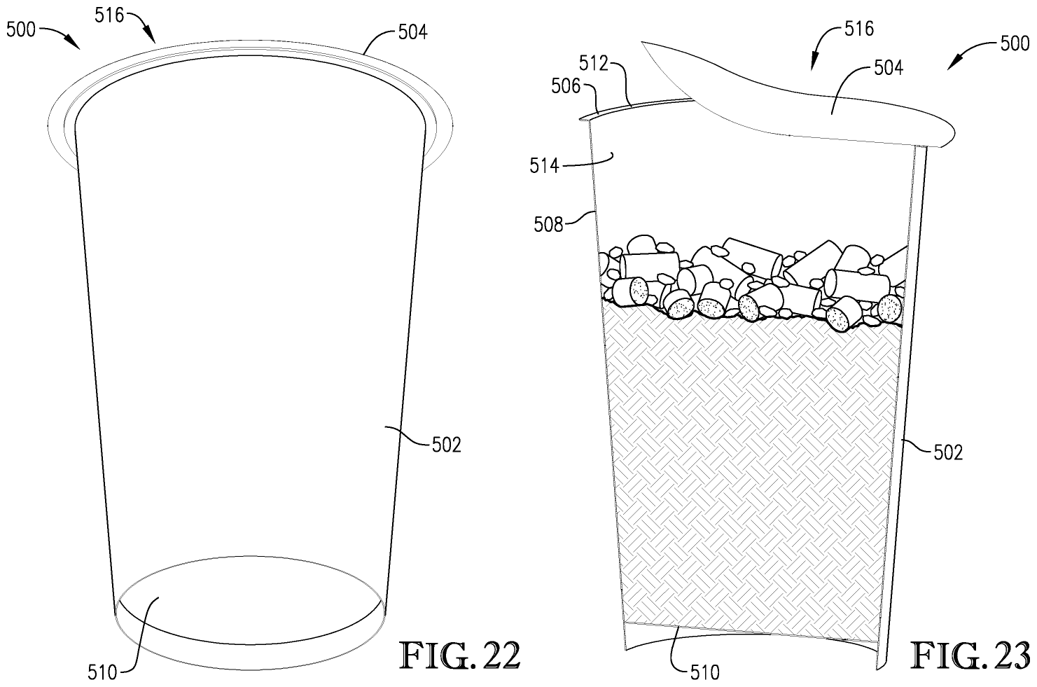

Turning to FIGS. 22 and 23, an alternative container 500 includes an elongated paper cup 502 and a filter layer 504. Cup 502 includes an alternative rim 506, a tubular sidewall 508, and a cup bottom 510. The alternative rim 506 preferably has a generally planar construction and presents an uppermost sealing surface 512 (see FIG. 23) for sealing engagement with the filter layer 504. Similar to containers 38, the alternative container 500 is configured to receive a mixture of substrate and spawn within an enclosed chamber 514 to provide a pre-filled container 516.

Various other aspects and advantages of the present invention will be apparent from the detailed description of the preferred embodiments and the accompanying drawing figures. While the drawings illustrate, and the specification describes, certain preferred embodiments of the invention, it is to be understood that such disclosure is by way of example only. There is no intent to limit the principles of the present invention to the particular disclosed embodiments. In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein. As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination. The present description may also use numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

1. A dual-use tray configured to be interchangeable with one or more other dual-use trays and configured to support colonized containers alongside one another, with the containers having upper and lower container elements, said dual-use tray comprising:
a plurality of upper tray locating structures and a plurality of lower tray locating structures, with the upper and lower tray locating structures attached relative to one another and spaced horizontally to at least partly define respective upper and lower tray surfaces,
each of said upper tray locating structures presenting an upper shoulder that forms part of the upper tray surface and is configured to locate the lower container element of a respective container,
each of said lower tray locating structures presenting a lower shoulder that forms part of the lower tray surface and is configured to locate the upper container element of a corresponding container.

2. The dual-use tray as claimed in claim 1, said upper and lower shoulders being horizontally aligned with each other so that the containers are vertically stacked and at least partly overlap one another.

3. The dual-use tray as claimed in claim 2, said upper and lower shoulders being coaxially aligned with one another.

4. The dual-use tray as claimed in claim 3, each of said upper tray locating structures including an arcuate upper ridge that defines the upper shoulder and each of said lower tray locating structures including an arcuate lower ridge that defines the lower shoulder.

5. The dual-use tray as claimed in claim 4, said upper shoulder of the upper ridge having a smaller diameter dimension than the lower shoulder of the lower ridge, with the upper shoulder comprising a male locating structure and the lower shoulder comprising a female locating structure.

6. The dual-use tray as claimed in claim 1, said upper tray locating structures comprising discrete platform surfaces spaced apart from one another to receive the base of respective containers.

7. The dual-use tray as claimed in claim 6, each of said upper tray locating structures including an arcuate upper ridge that defines the upper shoulder, with each platform surface surrounding a corresponding one of the upper ridges.

8. The dual-use tray as claimed in claim 6, each of said platform surfaces presenting a radially-extending groove to permit fluid flow below the base of respective containers.

9. The dual-use tray as claimed in claim 6, further comprising:
a plurality of recessed areas separating adjacent ones of the upper tray locating structures, with the recessed areas forming part of the upper tray surface and spaced below the upper tray locating structures.

10. The dual-use tray as claimed in claim 1, said upper tray locating structures being integrally formed with respective lower tray locating structures.

11. The dual-use tray as claimed in claim 10, said upper tray locating structures being coaxially aligned with the respective lower tray locating structures.

12. The dual-use tray as claimed in claim 10, further comprising:
an endless rim that surrounds the upper and lower tray locating structures and at least partly defines a channel extending below the upper tray locating structures.

13. The dual-use tray as claimed in claim 10, said lower tray locating structures comprising discrete covering surfaces spaced apart from one another to receive the upper rim of corresponding containers.

14. The dual-use tray as claimed in claim 13, each of said covering surfaces presenting a radially-extending groove to permit fluid flow into and out of corresponding containers.

15. The dual-use tray as claimed in claim 10, said tray presenting opposite forward and aft tray ends and defining a longitudinal axis, and one of said tray ends comprising a male end and the other tray end comprising a female end configured to receive the male end of another tray to restrict relative off-axis movement between adjacent trays.

16. A container assembly for a growing system, said container assembly comprising:
a supporting tray and a covering tray; and
a plurality of containers having upper and lower container elements, with the trays configured to cooperatively hold the containers,
said supporting tray including a plurality of supporting tray locating structures attached relative to one another and spaced horizontally to cooperatively define an upper supporting tray surface of the supporting tray,
said covering tray including a plurality of covering tray locating structures attached relative to one another and spaced horizontally to cooperatively define a lower covering tray surface of the covering tray,
said supporting tray locating structures being removably associated with respective covering tray locating structures to cooperatively engage the containers therebetween.

17. The container assembly as claimed in claim 16, each of said supporting tray locating structures presenting an upper shoulder that forms part of the upper tray surface and is configured to locate the lower container element of a respective container, and each of said covering tray locating structures presenting a lower shoulder that forms part of the lower tray surface and is configured to locate the upper container element of a corresponding container.

18. The container assembly as claimed in claim 17, said upper shoulders being aligned with respective lower shoulders so that each pair of aligned upper and lower shoulders cooperatively engage a corresponding container.

19. The container assembly as claimed in claim 18, each of said supporting tray locating structures including an arcuate upper ridge that defines the upper shoulder, and each of said covering tray locating structures presenting an arcuate lower ridge that defines the lower shoulder.

20. The container assembly as claimed in claim 19, said upper shoulder of the upper ridge having a smaller diameter dimension than the lower shoulder of the lower ridge, with the upper shoulder comprising a male locating structure and the lower shoulder comprising a female locating structure.

21. The container assembly as claimed in claim 16, said supporting tray locating structures being coaxially aligned with the respective covering tray locating structures when engaging the containers.

22. The container assembly as claimed in claim 16, said covering tray locating structures comprising discrete covering surfaces spaced apart from one another to receive the upper rim of corresponding containers.

23. The container assembly as claimed in claim 22, each of said covering surfaces presenting a radially-extending groove to permit fluid flow into and out of corresponding containers.

24. The container assembly as claimed in claim 16,
said supporting tray and said covering tray each including a plurality of upper tray locating structures and a plurality of lower tray locating structures, with the upper and lower tray locating structures attached relative to one another and spaced horizontally to at least partly define respective upper and lower tray surfaces,
each of said upper tray locating structures presenting an upper shoulder that forms part of the upper tray surface and is configured to locate the lower container element of a respective container,
each of said lower tray locating structures presenting a lower shoulder that forms part of the lower tray surface and is configured to locate the upper container element of a corresponding container.

25. The container assembly as claimed in claim 24, said trays comprising dual-use trays that are interchangeable with one another.

26. The container assembly as claimed in claim 24, said upper and lower shoulders being horizontally aligned with each other so that the containers are vertically stacked and at least partly overlap one another.

27. The container assembly as claimed in claim 26, said upper and lower shoulders being coaxially aligned with one another.

28. The container assembly as claimed in claim 27, each of said upper tray locating structures including an arcuate upper ridge that defines the upper shoulder and each of said lower tray locating structures including an arcuate lower ridge that defines the lower shoulder.

29. The container assembly as claimed in claim 28, said upper shoulder of the upper ridge having a smaller diameter dimension than the lower shoulder of the lower ridge, with the upper shoulder comprising a male locating structure and the lower shoulder comprising a female locating structure.

30. The container assembly as claimed in claim 24, said upper tray locating structures comprising discrete platform surfaces spaced apart from one another to receive the base of respective containers.

31. The container assembly as claimed in claim 30, each of said upper tray locating structures including an arcuate upper ridge that defines the upper shoulder, with each platform surface surrounding a corresponding one of the upper ridges.

32. The container assembly as claimed in claim 30, each of said platform surfaces presenting a radially-extending groove to permit fluid flow below the base of respective containers.

33. The container assembly as claimed in claim 30, each of said trays including a plurality of recessed areas separating adjacent ones of the upper tray locating structures, with the recessed areas forming part of the upper tray surface and spaced below the upper tray locating structures.

34. The container assembly as claimed in claim 24, said upper tray locating structures being integrally formed with respective lower tray locating structures.

35. The container assembly as claimed in claim 34, said upper tray locating structures being coaxially aligned with the respective lower tray locating structures.

36. The container assembly as claimed in claim 34, each of said trays including an endless rim that surrounds the upper and lower tray locating structures and at least partly defines a channel extending below the upper tray locating structures.

37. The container assembly as claimed in claim 34, said lower tray locating structures comprising discrete covering surfaces spaced apart from one another to receive the upper rim of corresponding containers.

38. The container assembly as claimed in claim 37, each of said covering surfaces presenting a radially-extending groove to permit fluid flow into and out of corresponding containers.

39. The container assembly as claimed in claim 16, each of said trays presenting opposite forward and aft tray ends and defining a longitudinal axis, and one of said tray ends comprising a male end and the other tray end comprising a female end configured to receive the male end of another tray to restrict relative off-axis movement between adjacent trays.

40. The container assembly as claimed in claim 16, each of said containers including a cup and a cover that cooperatively define an enclosed chamber.

41. The container assembly as claimed in claim 40, said cover comprising a permeable filter that permits the flow of gas and moisture into and/or out of the enclosed chamber, with the cover being removably attached to the cup.

42. The container assembly as claimed in claim 40, each of said containers including a colonized substrate received within the enclosed chamber for growing mushrooms.

43. A filtered container comprising:
an elongated cup including a continuous tubular sidewall and a cup bottom,
said sidewall extending vertically to present upper and lower ends, with the cup bottom fixed to the sidewall adjacent the lower end,
said sidewall including an endless rim extending along the upper end and defining an open top of the cup; and
a container cover removably attached to the endless rim to cover the open top, with the cup and container cover cooperatively defining an enclosed chamber,
said cup and said container cover each including a biodegradable base layer and an internal lining,
said internal lining being applied to the base layer to cover base layer surfaces within the chamber.

44. The filtered container as claimed in claim 43, said container cover comprising a permeable filter layer that permits the flow of gas into and/or out of the enclosed chamber.

45. The filtered container as claimed in claim 43, each of said containers including a colonized substrate received within the enclosed chamber for growing mushrooms.

46. A method of producing a colonized container for growing mushrooms, said method comprising the steps of:
providing a filtered container that includes a cup and a container cover, with the cup and container cover cooperatively defining an enclosed chamber; and
adding a mixture of spawn and substrate material to the chamber, with the spawn and substrate material cooperatively providing a colonized substrate.

47. A method of stacking alternating layers of containers and trays to form a container stack, with each tray including a plurality of upper tray locating structures and a plurality of lower tray locating structures, with the upper tray locating structures being coaxially aligned with the respective lower tray locating structures and the trays being interchangeable with one another, said method comprising the steps of:
having at least one of the trays selected as a lowermost tray in the container stack and positioned to receive containers;
having a first array of containers positioned on the lowermost tray in engagement with upper tray locating structures thereof; and
having at least one of the trays selected as a second tray above the lowermost tray in the container stack and positioned on the first array of containers so that the first array of containers engage lower tray locating structures of and cooperatively support the second tray.

48. The method as claimed in claim 47, further comprising the steps of:
having a second array of containers positioned on the second tray in engagement with upper tray locating structures thereof; and
having at least one of the trays selected as a third tray above the second tray in the container stack and positioned on the second array of containers so that the second array of containers engage lower tray locating structures of and cooperatively support the third tray.
